(19) United States
(12) Patent Application Publication
(10) Pub. No.: US 2020/0260016 A1
(43) Pub. Date: Aug. 13, 2020

(54) IMAGING DEVICE, OPERATION METHOD AND OPERATION PROGRAM THEREOF

(71) Applicant: FUJIFILM Corporation, Tokyo (JP)

(72) Inventors: Takeshi MISAWA, Saitama-shi (JP); Yoshikuni NISHIURA, Saitama-shi (JP); Takeharu OMATA, Saitama-shi (JP); Nanae SAKUMA, Saitama-shi (JP)

(73) Assignee: FUJIFILM Corporation, Tokyo (JP)

(21) Appl. No.: 16/863,369

(22) Filed: Apr. 30, 2020

Related U.S. Application Data
(63) Continuation of application No. PCT/JP2018/039533, filed on Oct. 24, 2018.

(30) Foreign Application Priority Data
Nov. 1, 2017 (JP) 2017-211532

(51) Int. Cl. H04N 5/232; G06F 3/0488

(52) U.S. Cl. CPC H04N 5/232945; H04N 5/232941; G06F 3/04883; H04N 5/232933

(57) ABSTRACT

A display control unit displays an enlarged image and a guide frame on a screen. First and second reception units (reception unit) receive a setting instruction for a correspondence relationship between an operation direction of a gesture operation and a movement direction of an enlargement display region. An information management unit (setting unit) sets the correspondence relationship in response to the setting instruction. A command output unit (deciding unit) decides a movement direction in a region of a captured image based on the correspondence relationship in a case where the gesture operation is performed. The display control unit moves the enlargement display region in the decided movement direction.

### CROSS-REFERENCE TO RELATED APPLICATIONS

This application is a Continuation of PCT International Application No. PCT/JP2018/039533 filed on 24 Oct. 2018, which claims priority under 35 U.S.C § 119(a) to Japanese Patent Application No. 2017-211532 filed on 1 Nov. 2017. The above application is hereby expressly incorporated by reference, in its entirety, into the present application.

### BACKGROUND OF THE INVENTION

### 1. Field of the Invention

The present invention relates to an imaging device, an operation method and an operation program thereof.

### 2. Description of the Related Art

In a digital camera which is an imaging device, a captured image recorded on a memory card or the like is reproduced and displayed on a screen of a display unit. In the reproduction display, an enlarged image obtained by enlarging a partial region of the captured image can be displayed on the screen in order to check a reflection state of the captured image in detail. The partial region of the captured image displayed as the enlarged image (hereinafter enlargement display region) can be freely moved within a region of the captured image.

In a case where the enlarged image is displayed, a guide frame indicating which portion of the captured image corresponds to the enlargement display region is displayed on the screen in addition to the enlarged image. The guide frame is composed of an outer frame indicating a region of the captured image and an inner frame indicating the enlargement display region. A size and a position of the outer frame are not changed, and the display thereof is fixed in the screen. On the other hand, a size of the inner frame is changed according to a change in an enlargement ratio. The position of the inner frame with respect to the outer frame is moved according to the movement of the enlargement display region in the region of the captured image.

Meanwhile, a digital camera employing a touch panel display as an operation unit is recently increased. The touch panel display has a transparent touch-type operation unit (also referred to as touch pad) disposed in an overlapped manner on the screen of the display unit and recognizes a gesture operation by a finger of a user touching the touch-type operation unit. The gesture operation includes, for example, a swipe operation and a flick operation. The swipe operation is an operation in which a finger is brought to touch the touch-type operation unit, is slowly moved in a certain direction, and then is released from the touch-type operation unit. The flick operation is an operation in which a finger is brought to touch the touch-type operation unit and is quickly swept in a certain direction to be released from the touch-type operation unit.

JP2015-172836A (corresponding to US2015/0264253A1) discloses a digital camera that moves the enlargement display region within the region of the captured image in response to the gesture operation on the touch-type operation unit in a case where the enlarged image is displayed. FIG. 10 in JP2015-172836A shows a state where the enlargement display region is moved upward in the region of the captured image in response to a downward swipe operation or flick operation on the touch-type operation unit and the inner frame of the guide frame is moved upward in the outer frame according to the movement of the enlargement display region. That is, in JP2015-172836A, the region of the captured image is moved downward with respect to the screen by the downward swipe operation or flick operation on the touch-type operation unit and thus the enlargement display region is relatively moved upward in the region of the captured image. It is an image that is moved upward.

### SUMMARY OF THE INVENTION

In the digital camera described in JP2015-172836A in which the enlargement display region is moved in response to the gesture operation on the touch-type operation unit, the operation direction of the gesture operation and the movement direction of the enlargement display region in response to the gesture operation are set in advance and fixed. Therefore, a user who feels uncomfortable in an initial operation with the fixed setting is required to perform the operation while dragging the uncomfortable feeling until the user is accustomed to the operation.

For example, it is assumed that there is a user who is accustomed to a digital camera in which settings of the operation direction of the gesture operation on the touch-type operation unit and the movement direction of the enlargement display region match. It is considered a case where the user operates a digital camera in which the settings of the operation direction of the gesture operation and the movement direction of the enlargement display region are different, such as the digital camera described in Patent Document 1. In this case, the user is confused due to the different setting from the digital camera to which the user is accustomed and may think for a moment before the operation or make an operation error.

An object of the present invention is to provide an imaging device that can be operated by a user without feeling uncomfortable, and an operation method and an operation program thereof.

In order to solve the above problems, an imaging device according to the present invention comprises a touch panel display, a display control unit, a reception unit, a setting unit, and a deciding unit. The touch panel display is composed of a display unit and a transparent touch-type operation unit disposed on a screen of the display unit in an overlapped manner. The display control unit displays an enlarged image obtained by enlarging a partial region of a captured image in a case where the captured image is reproduced and displayed on the screen, moves an enlargement display region, which is a partial region of the captured image to be displayed as the enlarged image, into a region of the captured image in response to a gesture operation performed by a finger of a user touching the touch-type operation unit, and displays a guide frame composed of the outer frame indicating the region of the captured image and an inner frame indicating the enlargement display region on the screen in addition to the enlarged image. The reception unit receives a setting instruction for a correspondence relationship between an operation direction of the gesture operation and a movement direction of the enlargement display region. The setting unit sets the correspondence relationship in response to the setting instruction. The deciding unit decides the movement direction in the region of the captured image based on the correspondence relationship in a case where the gesture operation is performed. The display control unit moves the enlargement display region in the movement direction decided by the deciding unit.

It is preferable that the display control unit moves the inner frame with respect to the outer frame according to the movement of the enlargement display region in a state where a display position of the outer frame in the screen is fixed, and switches between display and non-display of the guide frame according to the correspondence relationship.

It is preferable that the display control unit displays the guide frame in a case of the correspondence relationship in which the operation direction matches the movement direction, and does not display the guide frame in a case of the correspondence relationship in which the operation direction is different from the movement direction.

It is preferable that the reception unit receives an instruction to perform display or non-display of the guide frame, and the display control unit moves the inner frame with respect to the outer frame according to the movement of the enlargement display region in a state where a display position of the outer frame in the screen is fixed, and switches between the display and the non-display of the guide frame according to the instruction to perform the display or non-display of the guide frame.

It is preferable that the reception unit receives an instruction to perform the display of the guide frame as the setting instruction for the correspondence relationship in which the operation direction matches the movement direction, and receives an instruction to perform the non-display of the guide frame as the setting instruction for the correspondence relationship in which the operation direction is different from the movement direction.

It is preferable that the display control unit displays a first warning image for inquiring whether or not the non-display of the guide frame is allowed on the screen in a case where the guide frame is not displayed.

It is preferable that the display control unit switches the display of the guide frame, according to the correspondence relationship, between an inner frame movement type in which a display position of the outer frame in the screen is fixed and the inner frame is moved with respect to the outer frame according to the movement of the enlargement display region and an outer frame movement type in which a display position of the inner frame in the screen is fixed and the outer frame is moved with respect to the inner frame according to the movement of the enlargement display region.

It is preferable that the display control unit sets the inner frame movement type in a case of the correspondence relationship in which the operation direction matches the movement direction, and sets the outer frame movement type in a case of the correspondence relationship in which the operation direction is different from the movement direction.

It is preferable that the display control unit displays a second warning image for inquiring whether or not a setting in which the operation direction matches the movement direction is allowed on the screen in a case where the reception unit receives the setting instruction for the correspondence relationship in which the operation direction matches the movement direction.

It is preferable that a direction instruction key is further provided, and the display control unit moves the enlargement display region in a direction that matches a direction as instructed by the direction instruction key, and moves the inner frame with respect to the outer frame according to the movement of the enlargement display region in a state where the display position of the outer frame in the screen is fixed.

It is preferable that the gesture operation includes at least one of a swipe operation in which a finger is brought to touch the touch-type operation unit, is slowly moved in a certain direction, and then is released from the touch-type operation unit, or a flick operation in which a finger is brought to touch the touch-type operation unit and is quickly swept in a certain direction to be released from the touch-type operation unit.

An operation method of an imaging device according to the present invention comprises a touch panel display composed of a display unit and a transparent touch-type operation unit disposed on a screen of the display unit in an overlapped manner. The method comprises a display control step, a reception step, a setting step, and a deciding step. In the display control step, an enlarged image obtained by enlarging a partial region of a captured image is displayed in a case where the captured image is reproduced and displayed on the screen, an enlargement display region, which is a partial region of the captured image to be displayed as the enlarged image, is moved into a region of the captured image in response to a gesture operation performed by a finger of a user touching the touch-type operation unit, and a guide frame composed of an outer frame indicating the region of the captured image and an inner frame indicating the enlargement display region is displayed on the screen in addition to the enlarged image. In the reception step, a setting instruction for a correspondence relationship between an operation direction of the gesture operation and a movement direction of the enlargement display region is received. In the setting step, the correspondence relationship is set in response to the setting instruction. In the deciding step, the movement direction in the region of the captured image is decided based on the correspondence relationship in a case where the gesture operation is performed. In the display control step, the enlargement display region is moved in the movement direction decided in the deciding step.

An operation program of an imaging device according to the present invention comprises a touch panel display composed of a display unit and a transparent touch-type operation unit disposed on a screen of the display unit in an overlapped manner. The program causes a computer to execute a display control function, a reception function, a setting function, and a deciding function. The display control function displays an enlarged image obtained by enlarging a partial region of a captured image in a case where the captured image is reproduced and displayed on the screen, moves an enlargement display region, which is a partial region of the captured image to be displayed as the enlarged image, into a region of the captured image in response to a gesture operation performed by a finger of a user touching the touch-type operation unit, and displays a guide frame composed of an outer frame indicating the region of the captured image and an inner frame indicating the enlargement display region on the screen in addition to the enlarged image. The reception function receives a setting instruction for a correspondence relationship between an operation direction of the gesture operation and a movement direction of the enlargement display region. The setting function sets the correspondence relationship in response to the setting instruction. The deciding function decides the movement direction in the region of the captured image based on the correspondence relationship in a case where the gesture operation is performed. The display control function moves the enlargement display region in the movement direction decided by the deciding function.

In the present invention, the correspondence relationship between the operation direction of the gesture operation on the touch-type operation unit and the movement direction of the enlargement display region is set in response to the setting instruction, the movement direction of the enlargement display region in the region of the captured image is decided based on the correspondence relationship in the case where the gesture operation is performed, and the enlargement display region is moved in the decided movement direction. Therefore, it is possible to set the correspondence relationship according to the preference of the user and move the enlargement display region based on this correspondence relationship. Therefore, it is possible to provide an imaging device that can be operated by a user without feeling uncomfortable, and an operation method and an operation program thereof.

### BRIEF DESCRIPTION OF THE DRAWINGS

FIG. 1 is a front external perspective view of a digital camera.

FIG. 2 is a rear external perspective view of the digital camera.

FIG. 3 is a schematic diagram of a touch panel display.

FIG. 4 is a diagram showing a state of a swipe operation or a flick operation.

FIGS. 5A and 5B are diagrams showing a state of reproduction display of a captured image. FIG. 5A shows a state where a pinch-out operation is performed on a portion of a touch-type operation unit corresponding to a face of a person and FIG. 5B shows a state where an enlarged image obtained by enlarging a region of the face of the person is displayed, respectively.

FIG. 6 is a diagram showing an enlargement ratio display bar and a guide frame.

FIG. 7 is a diagram showing a setting image.

FIG. 8 is a block diagram of the digital camera.

FIG. 9 is a block diagram of a CPU of the digital camera.

FIG. 10 is a table showing gesture operation recognition information.

FIG. 11 is a table showing command conversion information.

FIG. 12 is a table showing first correspondence relationship information.

FIG. 13 is a table showing second correspondence relationship information.

FIG. 14 is a table showing another example of the first correspondence relationship information.

FIG. 15 is a diagram schematically showing a state where a first correspondence relationship is set.

FIG. 16 is a diagram schematically showing a state where a movement direction of an enlargement display region is decided based on the first correspondence relationship and the enlargement display region is moved in the decided movement direction.

FIG. 17 is a diagram schematically showing a state where a movement direction of the enlargement display region is decided based on a second correspondence relationship and the enlargement display region is moved in the decided movement direction.

FIG. 18 is a flowchart showing a processing procedure of the digital camera.

FIG. 19 is a flowchart showing a processing procedure of the digital camera.

FIGS. 20A and 20B are diagrams showing a second embodiment in which display and non-display of a guide frame are switched according to the first correspondence relationship.

FIG. 20A shows a case where an operation direction of a swipe operation or a flick operation matches the movement direction of the enlargement display region and FIG. 20B shows a case where the operation direction of the swipe operation or the flick operation is different from the movement direction of the enlargement display region, respectively.

FIG. 21 is a diagram showing a first warning image.

FIG. 22 is a flowchart showing a processing procedure of a digital camera according to the second embodiment.

FIG. 23 is a flowchart showing a processing procedure of a digital camera according to the second embodiment.

FIG. 24 is a flowchart showing a processing procedure of a digital camera according to the second embodiment.

FIG. 25 is a table showing switching between display and non-display of the guide frame in a case where the operation direction of the swipe operation or the flick operation and the movement direction of the enlargement display region partially match and partially differ.

FIG. 26 is a diagram showing a display setting image.

FIGS. 27A and 27B are diagrams showing functions of first and second reception units according to a third embodiment. FIG. 27A shows a case where a display setting instruction is to perform the display of the guide frame and FIG. 27B shows a case where the display setting instruction is to perform the non-display of the guide frame, respectively.

FIG. 28 is a flowchart showing a processing procedure of a digital camera according to the third embodiment.

FIG. 29 is a flowchart showing a processing procedure of the digital camera according to the third embodiment.

FIG. 30 is an explanatory diagram of an outer frame movement type.

FIGS. 31A and 31B are diagrams showing a function of a display control unit according to a fourth embodiment. FIG. 31A shows a case of a first correspondence relationship in which the operation direction of the swipe operation or the flick operation matches the movement direction of the enlargement display region and FIG. 31B shows a case of a first correspondence relationship in which the operation direction of the swipe operation or the flick operation is different from the movement direction of the enlargement display region, respectively.

FIG. 32 is a flowchart showing a processing procedure of a digital camera according to a fourth embodiment.

FIG. 33 is a flowchart showing a processing procedure of the digital camera according to the fourth embodiment.

FIG. 34 is a diagram showing a second warning image.

### DESCRIPTION OF THE PREFERRED EMBODIMENTS

### First Embodiment

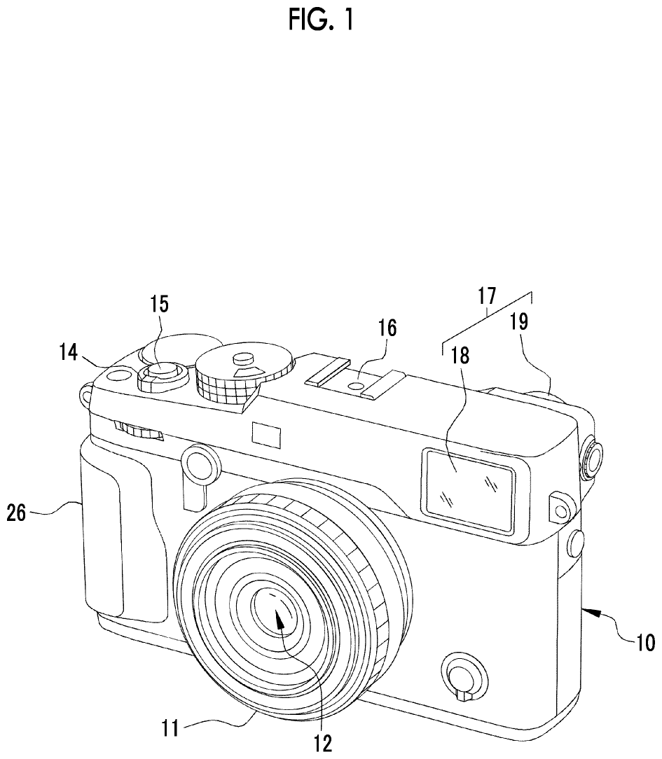

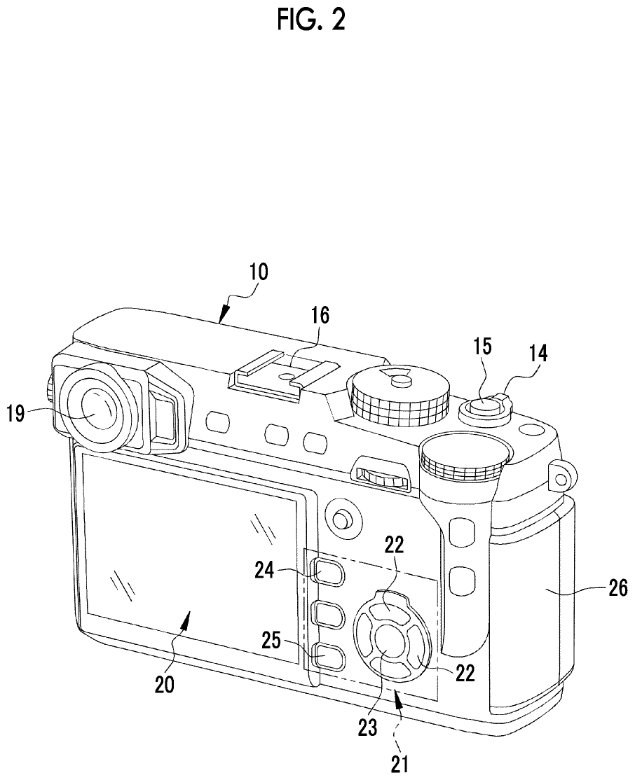

In FIGS. 1 and 2, a lens barrel 11 is provided on a front surface of a digital camera 10 as an imaging device. An imaging optical system 12 is built in the lens barrel 11. The lens barrel 11 is interchangeable, and the digital camera 10 is a so-called lens interchangeable type.

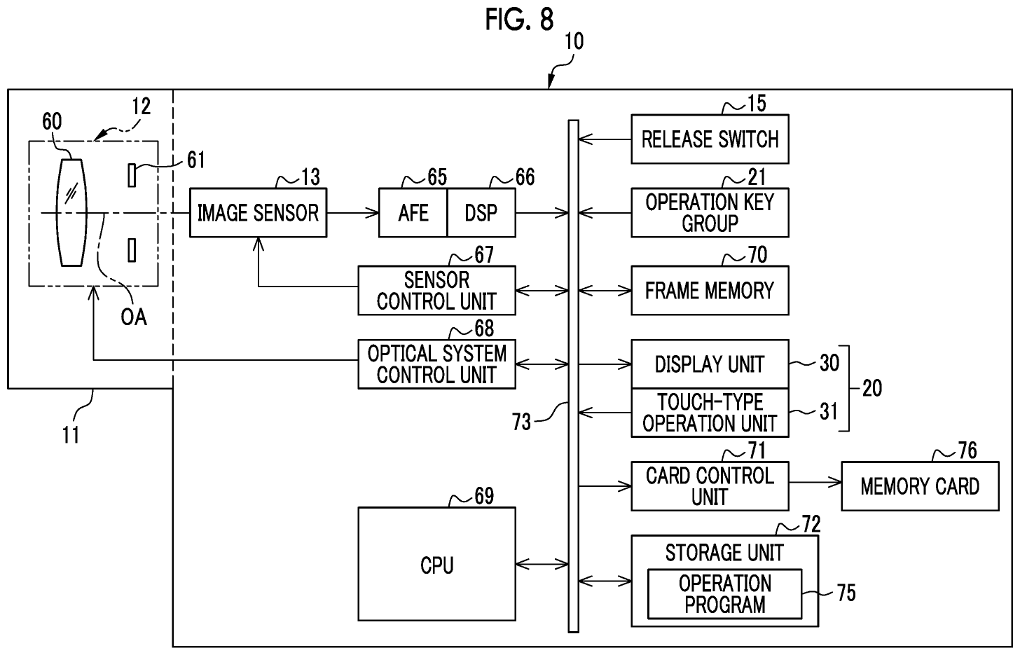

An image sensor 13 is disposed behind the lens barrel 11 (refer to FIG. 8). The image sensor 13 is, for example, a charge coupled device (CCD) type or a complementary metal oxide semiconductor (CMOS) type, and has a rectangular imaging surface. A plurality of pixels are arranged in a matrix on the imaging surface. The pixel photoelectrically converts a subject image formed on the imaging surface through the imaging optical system 12 and outputs an imaging signal which is a source of image data of a subject.

A power lever 14, a release switch 15, a hot shoe 16 and the like are provided on an upper surface of the digital camera 10. The power lever 14 is operated in a case where the digital camera 10 is turned on and off. An external flash device is attachably and detachably attached to the hot shoe 16.

The release switch 15 is operated in a case where still picture imaging is instructed or in a case where a start and an end of motion picture imaging is instructed. The release switch 15 is a two-stage press type. In a case where the release switch 15 is pressed down to a first stage (half-pressed), well-known imaging preparation processing such as automatic focus adjustment or automatic exposure control is executed. In a case where the release switch 15 is pressed down to a second stage (fully pressed), the image sensor 13 is caused to execute a main imaging operation (operation of accumulating charges in pixels and outputting an imaging signal corresponding to the accumulated charges). As a result, imaging processing of recording image data output from the image sensor 13 as a captured image is executed.

A viewfinder part 17 has an object window 18 which is disposed on the front surface and through which the subject image is captured, and an eyepiece window 19 which is disposed on a rear surface and through which an eye of a user views. It is possible for the user to check the composition of the subject image to be imaged through the viewfinder part 17.

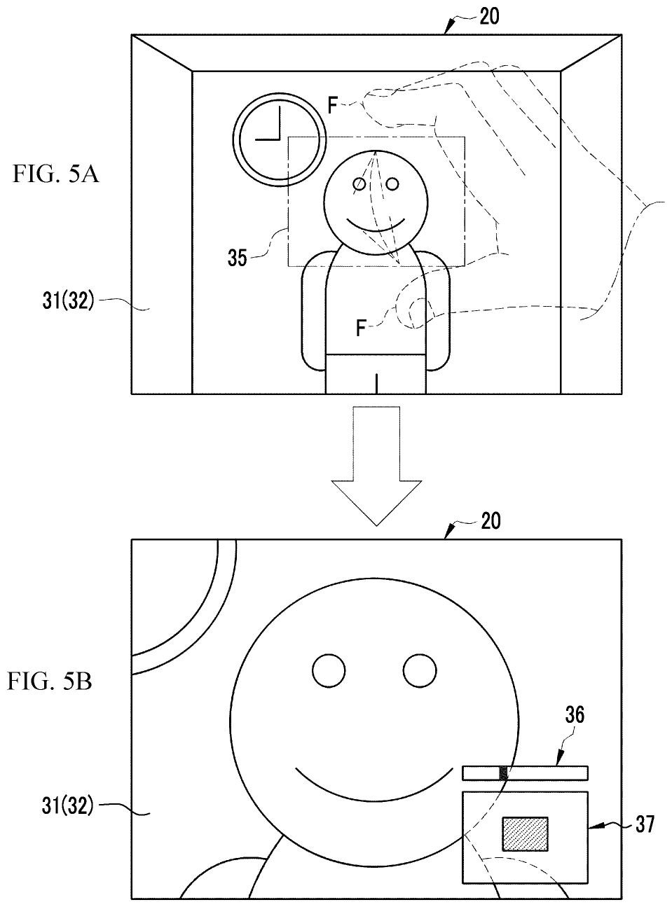

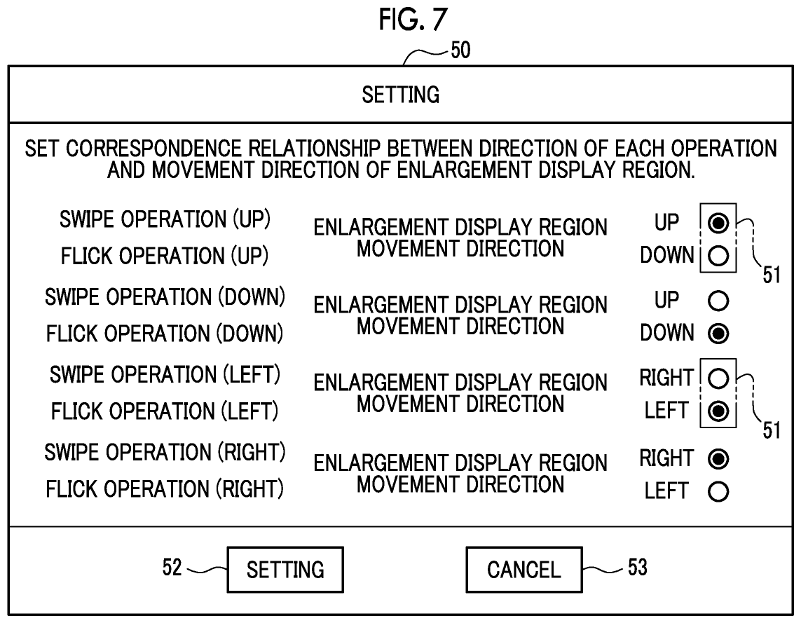

A touch panel display 20, an operation key group 21, and the like are provided on the rear surface of the digital camera 10. The touch panel display 20 performs a so-called live view display that displays the captured image of the subject represented by the image data from the image sensor 13 in real time. In addition to the live view display, the touch panel display 20 performs reproduction display of a recorded captured image (refer to FIG. 5) and displays various images such as a setting image 50 (refer to FIG. 7).

The operation key group 21 is composed of a direction instruction key 22, a menu/decision key 23, a reproduction display key 24, a return key 25, and the like. The direction instruction key 22 is composed of four keys for performing an instruction for respective directions of up, down, left, and right, and is operated in a case where various selection candidates are selected. The menu/decision key 23 is disposed at the center of the operation key group 21 and is operated in a case where the selection of a selection candidate is confirmed. The reproduction display key 24 is operated in a case where the captured image is reproduced and displayed on the touch panel display 20. The return key 25 is operated in a case where a display format is returned from the reproduction display to the live view display, in a case where the enlarged display of the captured image is stopped, or the like. Hereinafter, an operation on the operation key group 21 is referred to as a key operation. A portion indicated by a reference sign 26 in FIGS. 1 and 2 is a lid for covering a memory card slot in which a memory card 76 (refer to FIG. 8) is attachably and detachably mounted.

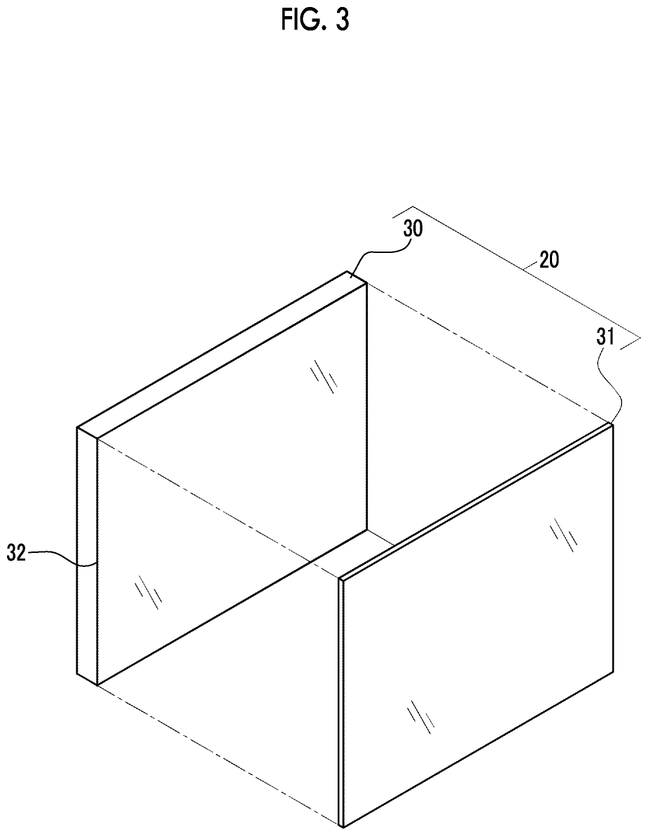

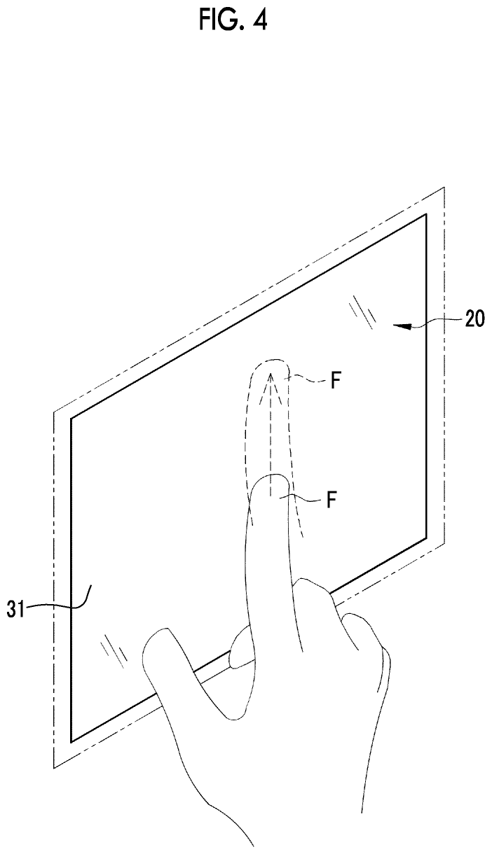

FIG. 3 schematically represents a configuration of the touch panel display 20. The touch panel display 20 is composed of a display unit 30 and a touch-type operation unit 31. The display unit 30 is, for example, a liquid crystal display, and a screen 32 thereof displays the various images as described above. As is well known, the touch-type operation unit 31 has two layers of transparent electrodes that are orthogonal to each other, a transparent insulating layer that separates the two layers of transparent electrodes, and a transparent protection cover that covers the uppermost layer. The touch-type operation unit 31 detects a touch of a finger F of the user (refer to FIG. 4) with the transparent electrode and outputs a detection signal. The touch-type operation unit 31 is disposed on the screen 32 of the display unit 30 in an overlapped manner. The touch panel display 20 is attached to the rear surface of the digital camera 10 as shown in FIG. 2 in a state where the display unit 30 and the touch-type operation unit 31 are integrated.

The touch panel display 20 recognizes a gesture operation by the finger F of the user touching the touch-type operation unit 31. The gesture operation includes, for example, a swipe operation and a flick operation. The swipe operation is an operation in which the finger F is brought to touch the touch-type operation unit 31, is slowly moved in a certain direction, and then is released from the touch-type operation unit 31. The flick operation is an operation in which the finger F is brought to touch the touch-type operation unit 31 and is quickly swept in a certain direction to be released from the touch-type operation unit 31. The swipe operation or the flick operation is performed in a case where various selection candidates are selected, similar to the direction instruction key 22 of the operation key group 21.

FIG. 4 shows a state of an upward swipe operation or flick operation on the touch-type operation unit 31. The user brings the finger F (here, index finger) into touch with an appropriate position of the touch-type operation unit 31, slowly moves the finger F upward (swipe operation) or quickly sweeps the finger F upward (flick operation) as indicated by a dashed arrow, and then releases the finger F from the touch-type operation unit 31.

The gesture operation includes a tap operation, a pinch-in operation, a pinch-out operation, and the like, in addition to the swipe operation and the flick operation illustrated in FIG. 4. The tap operation is an operation of tapping the touch-type operation unit 31 with the finger F and includes a single tap operation of tapping once and a double tap operation of tapping twice consecutively. The pinch-in operation is an operation in which at least two fingers F such as the thumb and the index finger are brought into touch with the touch-type operation unit 31 in a state where the two fingers are separated and then the two fingers F are moved in directions approaching each other. On the contrary, the pinch-out operation is an operation in which two fingers F are brought into touch with the touch-type operation unit 31 in a state where the two fingers approach and then the two fingers F are moved in directions away from each other (refer to FIG. 5A).

The tap operation is performed in a case where the selection of a selection candidate is confirmed, similar to the menu/decision key 23 of the operation key group 21. The pinch-in operation is performed in a case where a captured image subjected to the reproduction display is reduced, and the pinch-out operation is performed in a case where a captured image subjected to the reproduction display is enlarged (refer to FIG. 5A).

FIG. 5A shows a state where the reproduction display key 24 is operated and the captured image is reproduced and displayed on the touch panel display 20. The captured image has a composition in which a face of a person is at the center, a clock is on the left side of the face of the person, walls of a room is on the left and right, and the ceiling is on the upper side. With this state, in a case where the pinch-out operation is performed on a portion of the touch-type operation unit 31 corresponding to the face of the person as shown by a broken line, an enlarged image obtained by enlarging a region of the face of the person, which is a partial region of the captured image, is displayed on the screen 32 as shown in FIG. 5B. Hereinafter, the partial region of the captured image displayed as the enlarged image is referred to as an enlargement display region 35. The center of the enlargement display region 35 is located at, for example, an intermediate point connecting touch positions of two fingers in the pinch-in operation and the pinch-out operation with a straight line.

In a state shown in FIG. 5B in which the enlarged image is displayed, an enlargement ratio display bar 36 and a guide frame 37 are displayed at the right corner of the screen 32. The enlargement ratio display bar 36 and the guide frame 37 are displayed in a semi-transparent state. Therefore, a region overlapping the enlargement ratio display bar 36 and the guide frame 37 is transparent and can be visually recognized by the user.

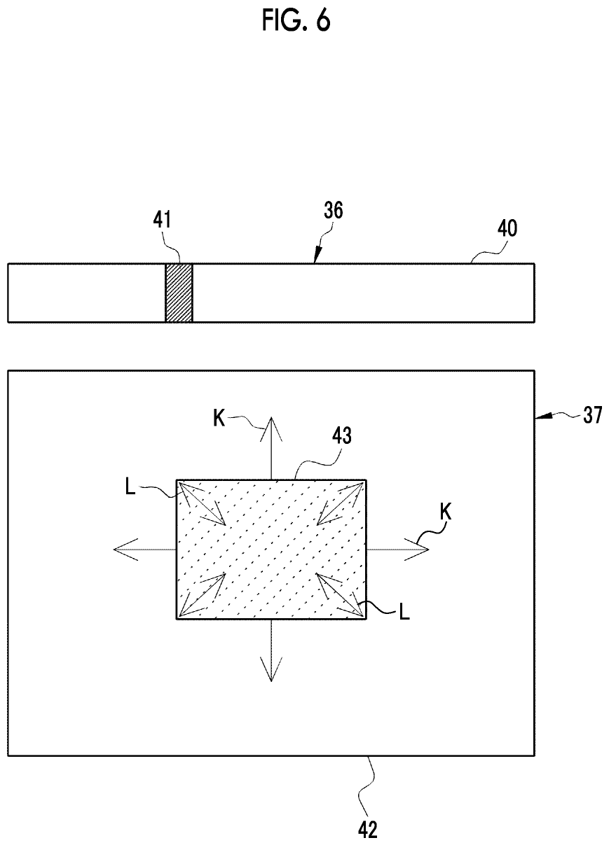

As shown in FIG. 6, the enlargement ratio display bar 36 is composed of a horizontally long bar body 40 and a mark 41 that moves in the bar body 40 according to the enlargement ratio. The mark 41 moves to the right side as the enlargement ratio increases (enlargement display region 35 decreases). That is, the mark 41 is located at the left end of the bar main body 40 in a case where an enlarged image close to the original unenlarged captured image is displayed. The mark 41 moves toward the right end of the bar body 40 as the enlarged image of a smaller region of the captured image is displayed.

The guide frame 37 is composed of an outer frame 42 indicating the region of the captured image and an inner frame 43 indicating the enlargement display region 35. The inner frame 43 is colored in a predetermined color (for example, black) as indicated by hatching. A display position of the outer frame 42 in the screen 32 is fixed. On the other hand, the position of the inner frame 43 with respect to the outer frame 42 is moved up, down, left, and right according to the movement of the enlargement display region 35 in the region of the captured image, as indicated by an arrow K. The size of the inner frame 43 is changed according to a change in the enlargement ratio, as indicated by an arrow L.

In FIG. 7, the setting image 50 is an operation image to be displayed on the screen 32 in a case where a correspondence relationship (hereinafter first correspondence relationship) between the operation direction of the swipe operation or the flick operation which is the gesture operation and the movement direction of the enlargement display region 35 is set.

The setting image 50 is provided with a radio button 51 for selectively setting the movement direction of the enlargement display region 35 with respect to respective directions of up, down, left, and right of the swipe operation or the flick operation to any one of up, down, left, and right, a setting button 52, and a cancel button 53. In a case where the setting button 52 is selected, a selected state of the radio button 51 at the time is set as the first correspondence relationship. On the other hand, in a case where the cancel button 53 is selected, the setting image 50 is deleted from the screen 32.

In a case where the movement direction of the enlargement display region 35 is set to up for an upward swipe operation or flick operation, the movement direction of the enlargement display region 35 for a downward swipe operation or flick operation is automatically set to down. On the other hand, in a case where the movement direction of the enlargement display region 35 is set to down for the upward swipe operation or flick operation, the movement direction of the enlargement display region 35 for the downward swipe operation or flick operation is automatically set to up.

Similarly, in a case where the movement direction of the enlargement display region 35 is set to left for a leftward swipe operation or flick operation, the movement direction of the enlargement display region 35 for a rightward swipe operation or flick operation is automatically set to right. On the other hand, in a case where the movement direction of the enlargement display region 35 is set to right for the leftward swipe operation or flick operation, the movement direction of the enlargement display region 35 for the rightward swipe operation or flick operation is automatically set to left.

In FIG. 7, the movement direction of the enlargement display region 35 for the upward swipe and flick operations is set to up, and the movement direction of the enlargement display region 35 for the downward swipe and flick operations is set to down, respectively. The movement direction of the enlargement display region 35 for the leftward swipe and flick operations is set to left, and the movement direction of the enlargement display region 35 for the rightward swipe and flick operations is set to right, respectively. As described above, the operation direction of the swipe operation or the flick operation matches the movement direction of the enlargement display region 35. The movement direction of the enlargement display region 35 may be fixed to left for the leftward swipe and flick operations and may be fixed to right for the right swipe and flick operations, respectively, and the settings may be not changeable. The movement direction of the enlargement display region 35 may be changeable only for the upward and downward swipe and flick operations.

The enlargement display region 35 can be moved not only by the swipe and flick operations but also by the operation of the direction instruction key 22. However, a correspondence relationship (hereinafter second correspondence relationship) between the operation direction of the direction instruction key 22 and the corresponding movement direction of the enlargement display region 35 is different from the first correspondence relationship and is fixed in advance, and thus the setting is not changeable.

That is, the movement direction of the enlargement display region 35 is set to up for the upward operation of the direction instruction key 22 and is set to down for the downward operation of the direction instruction key 22, respectively. The movement direction of the enlargement display region 35 is set to left for the leftward operation of the direction instruction key 22 and is set to right for the rightward operation of the direction instruction key 22, respectively (refer to FIG. 13). As described above, the operation direction of the direction instruction key 22 matches the movement direction of the enlargement display region 35.

In FIG. 8, the imaging optical system 12 comprises a movable lens 60 and a stop mechanism 61. The movable lens 60 is a focus lens for focus adjustment and a zoom lens for zoom, and moves along an optical axis OA. The stop mechanism 61 has a plurality of stop leaf blades, as is well known. The stop leaf blades form a substantially circular aperture stop, and a size of the aperture stop is changed to limit an amount of incident light. Although not shown or described, the imaging optical system 12 has various lenses in addition to the movable lens 60.

The digital camera 10 comprises an analog front end (AFE) 65, a digital signal processor (DSP) 66, a sensor control unit 67, an optical system control unit 68, a central processing unit (CPU) 69, a frame memory 70, a card control unit 71, and a storage unit 72. These are connected to each other by a data bus 73.

The AFE 65 performs correlative double sampling processing or amplification processing, and analog/digital conversion processing on an analog imaging signal from the image sensor 13 to convert the analog imaging signal into image data having a gradation value corresponding to a predetermined number of bits, and outputs the image data to the DSP 66. The DSP 66 performs well-known signal processing such as gamma-correction processing, defective pixel correction processing, white balance correction processing, and demosaicing on the image data from the AFE 65.

The sensor control unit 67 controls the operation of the image sensor 13. Specifically, the sensor control unit 67 outputs a sensor control signal synchronized with a reference clock signal to be input from the CPU 69 to the image sensor 13 and causes the image sensor 13 to output the imaging signal at a predetermined frame rate.

The optical system control unit 68 moves the movable lens 60 to a focusing position during automatic focus adjustment. The optical system control unit 68 opens and closes the stop leaf blades of the stop mechanism 61 such that a calculated opening is obtained, during the automatic exposure control.

The CPU 69 integrally controls the operation of each unit of the digital camera 10 based on an operation program 75 stored in the storage unit 72. For example, the CPU 69 executes the imaging preparation processing in response to the half press of the release switch 15 and executes the imaging processing in response to the full press of the release switch 15. Further, the CPU 69 executes processing according to an operation signal from the operation key group 21. FIG. 8 illustrates only the release switch 15 and the operation key group 21. However, other operation units such as the power lever 14 described above are also connected to the data bus 73, and processing according to operation signals from the other units is executed by the CPU 69.

The frame memory 70 stores one-frame image data subjected to various types of signal processing by the DSP 66. The image data to be stored in the frame memory 70 is updated at any time at a predetermined frame rate.

The card control unit 71 controls recording of the captured image on the memory card 76 and reading out of the captured image from the memory card 76. In the imaging processing accompanying the full press of the release switch 15, the card control unit 71 records the image data stored in the frame memory 70 at the time on the memory card 76 as the captured image.

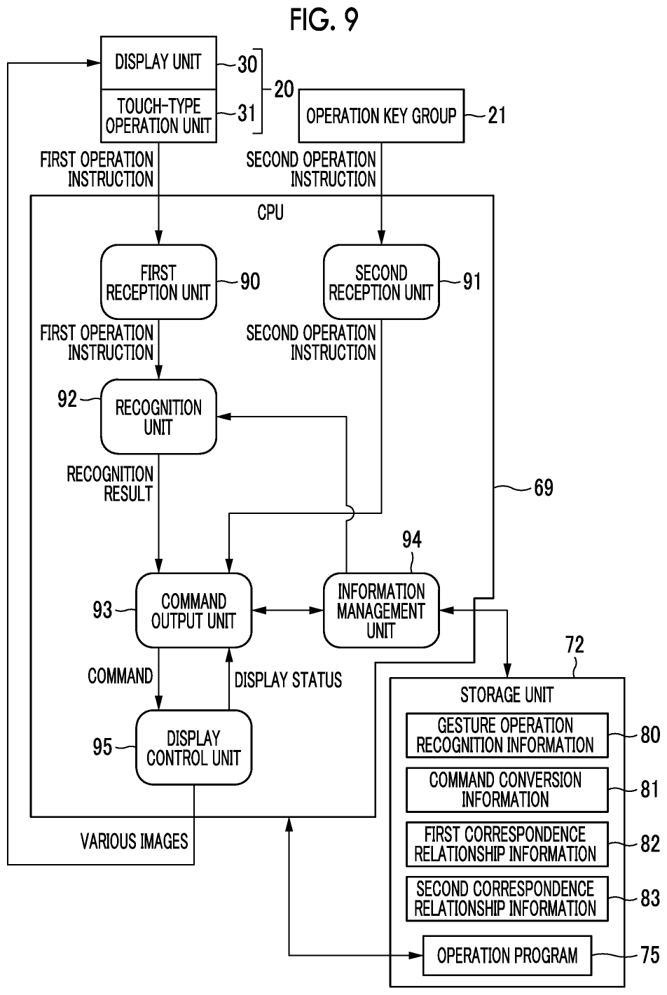

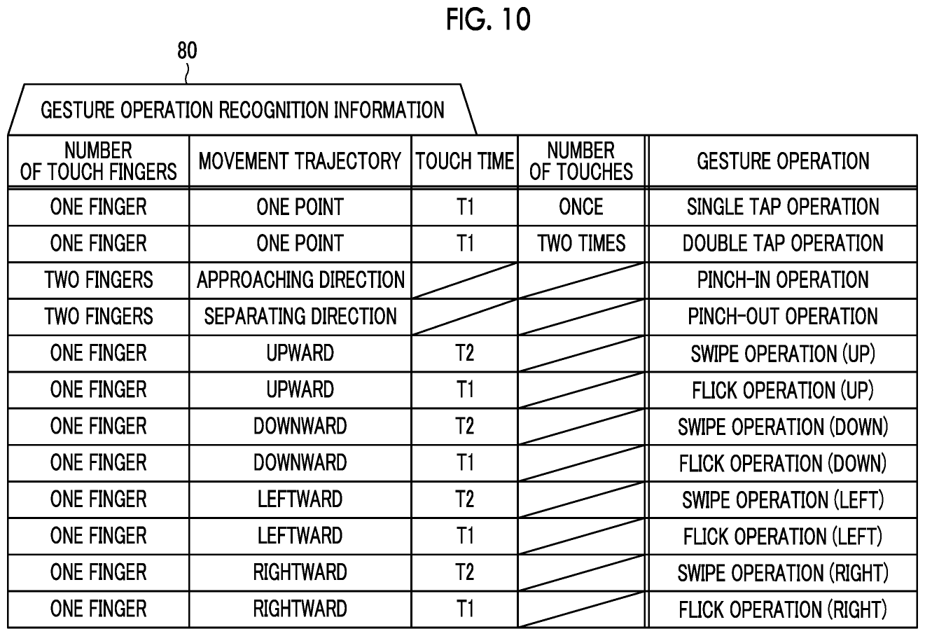

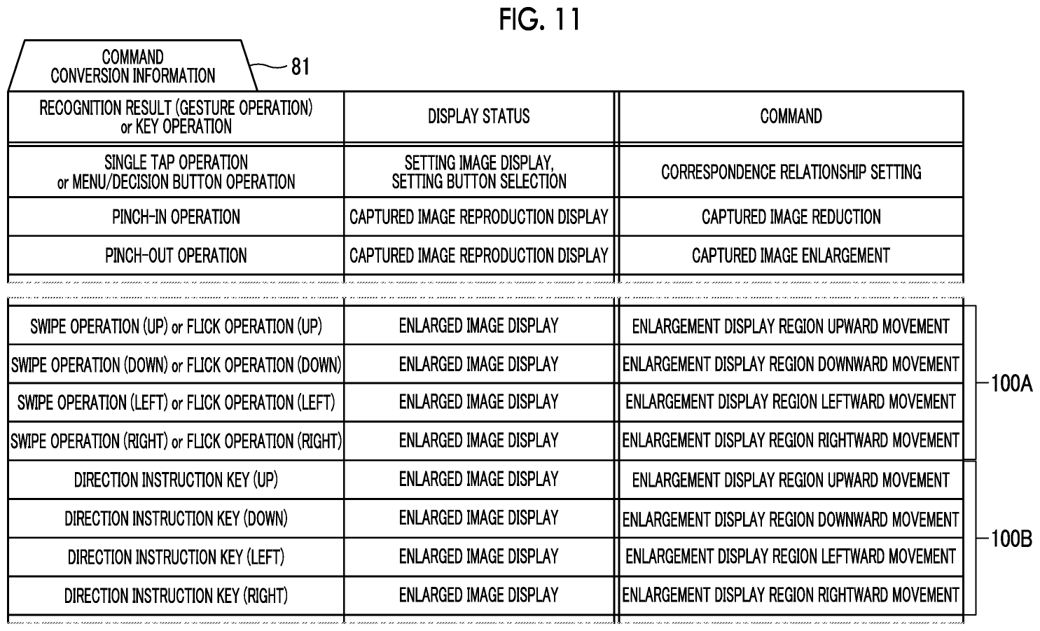

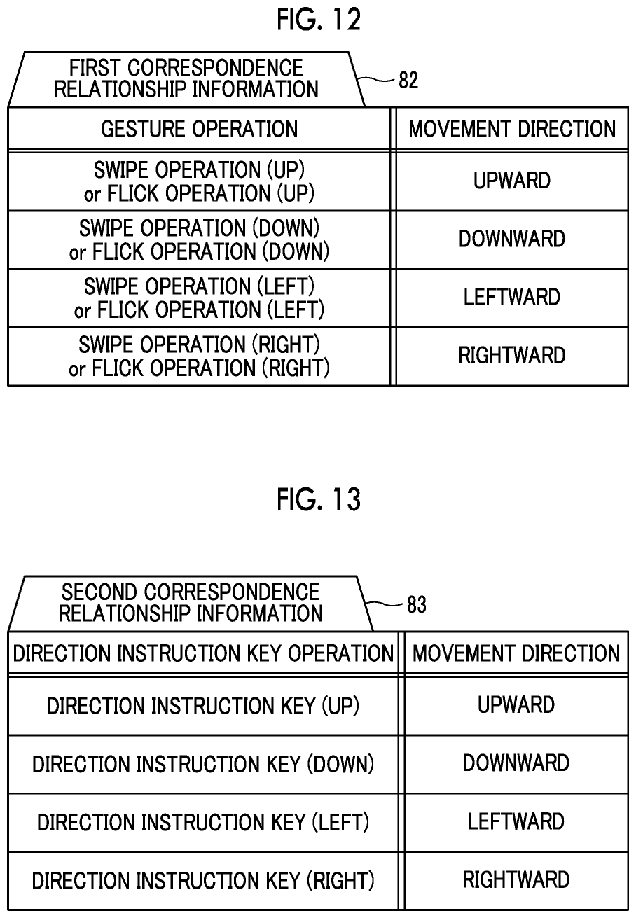

In FIG. 9, the storage unit 72 stores gesture operation recognition information 80 (refer to FIG. 10), command conversion information 81 (refer to FIG. 11), first correspondence relationship information 82 (refer to FIG. 12), and second correspondence relationship information 83 (refer to FIG. 13), in addition to the above operation program 75.

In a case where the operation program 75 is activated, the CPU 69 functions as a first reception unit 90, a second reception unit 91, a recognition unit 92, a command output unit 93, an information management unit 94, and a display control unit 95.

The first reception unit 90 receives an operation instruction by the gesture operation (hereinafter first operation instruction) performed on the touch-type operation unit 31. The first reception unit 90 outputs the first operation instruction to the recognition unit 92. On the other hand, the second reception unit 91 receives an operation instruction by the key operation performed on the operation key group 21 (hereinafter second operation instruction). The second reception unit 91 outputs the second operation instruction to the command output unit 93.

The first operation instruction includes a touch position of the finger F on the touch-type operation unit 31, coordinate information indicating a movement trajectory thereof, and information such as the number of touch fingers F, a touch time, and the number of touches per unit time on the touch-type operation unit 31. The coordinate is, for example, two sets of numbers indicating an intersection of the two layers of transparent electrodes that constitute the touch-type operation unit 31 and are orthogonal to each other. On the other hand, the second operation instruction is an operation signal of any one of the up, down, left, and right keys of the direction instruction key 22, information indicating an operation time thereof, and an operation signal of the menu/decision key 23.

The first operation instruction and the second operation instruction include a setting instruction for the first correspondence relationship. The setting instruction is output from the touch-type operation unit 31 to the first reception unit 90 or from the operation key group 21 to the second reception unit 91 in a case where the setting button 52 of the setting image 50 is selected. That is, the first reception unit 90 and the second reception unit 91 correspond to a reception unit that receives the setting instruction and have a reception function of the setting instruction.

The recognition unit 92 refers to the gesture operation recognition information 80 to recognize which of the above swipe operation, flick operation, tap operation, pinch-in operation, pinch-out operation, or the like is the gesture operation which is a source of the first operation instruction from the first reception unit 90. In a case of the swipe operation, the flick operation, the pinch-in operation, and the pinch-out operation, a movement amount and a movement speed of the finger F are recognized from the movement trajectory of the finger F. The recognition unit 92 outputs a recognition result to the command output unit 93.

The command output unit 93 refers to the command conversion information 81 and a display status from the display control unit 95 to convert the recognition result from the recognition unit 92 and the second operation instruction from the second reception unit 91 into a command. The converted command is output to various processing units such as the information management unit 94 and the display control unit 95. The command is obtained by converting the recognition result (in other words, the first operation instruction) and the second operation instruction into a form that can be understood by the information management unit 94, the display control unit 95, and the like. The display status is information indicating a display situation of various images on the screen 32 of the display unit 30, such as a reproduction display state of the captured image including a size (enlargement ratio) and a position of the enlargement display region 35.

The information management unit 94 manages writing of various pieces of information 80 to 83 into the storage unit 72 and reading out of various pieces of information 80 to 83 from the storage unit 72. For example, the information management unit 94 passes the gesture operation recognition information 80 to the recognition unit 92 and passes the command conversion information 81 to the command output unit 93.

The display control unit 95 has a display control function of controlling the display of the various images on the screen 32 of the display unit 30. The display control unit 95 outputs the display state of the various images to the command output unit 93 as the display status. Therefore, the command output unit 93 always grasps the display status.

In FIG. 10, the gesture operation recognition information 80 is information in which the gesture operation for the number of touch fingers F, the movement trajectory, the touch time, and the number of touches per unit time on the touch-type operation unit 31 is registered. For example, in a case where the number of touch fingers is one, the movement trajectory is one point, the touch time is T1 (for example, less than one second), and the number of touches is once, the single tap operation is registered. In a case where the number of touch fingers is one, the movement trajectory is upward, and the touch time is T2 (for example, one second or more), the upward swipe operation is registered. In a case where the number of touch fingers and the movement trajectory are the same and the touch time is T1, the upward flick operation is registered.

The recognition unit 92 extracts, from the gesture operation recognition information 80, a gesture operation that matches the number of touch fingers F, the movement trajectory, the touch time, and the number of touches per unit time on the touch-type operation unit 31 which are included in the first operation instruction from the first reception unit 90. The extracted gesture operation is output to the command output unit 93 as the recognition result. For example, in a case where the number of touch fingers F on the touch-type operation unit 31 is two and the movement trajectory thereon is in a separating direction, which are included in the first operation instruction, the recognition unit 92 extracts the pinch-out operation from the gesture operation recognition information 80 and outputs the extracted pinch-out operation to the command output unit 93.

In FIG. 11, the command conversion information 81 is information in which the command for the recognition result (gesture operation) or the key operation, and the display status is registered. For example, in a case where the single tap operation is performed as the gesture operation or in a case where the menu/decision key 23 is operated as the key operation in a display status where the setting button 52 is selected in the setting image 50, a command to set the first correspondence relationship is registered.

In a case where the pinch-in operation is performed as the gesture operation in a display status shown in FIG. 5A in which the captured image is reproduced and displayed, a command to reduce the captured image is registered. On the other hand, in a case where the pinch-out operation is performed in the same display status, a command to enlarge the captured image is registered.

Further, in a case where, for example, the upward swipe operation or flick operation is performed as the gesture operation in a display status shown in FIG. 5B in which the enlarged image is reproduced and displayed, a command to move the enlargement display region 35 upward is registered. In addition, in a case where the upward operation of, for example, the direction instruction key 22 is performed as the key operation in the same display status, the command to move the enlargement display region 35 upward is registered.

In FIG. 12, the first correspondence relationship information 82 is information in which the operation direction of the swipe operation or the flick operation and the movement direction of the enlargement display region 35, that is, the first correspondence relationship is registered. Here, the first correspondence relationship shown in FIG. 7 is registered. Similarly, in FIG. 13, the second correspondence relationship information 83 is information in which the operation direction of the direction instruction key 22 and the movement direction of the enlargement display region 35, that is, the second correspondence relationship is registered. Here, the second correspondence relationship in which the operation direction of the direction instruction key 22 matches the movement direction of the enlargement display region 35 is registered.

Contents of the first correspondence relationship information 82 are rewritten in response to the setting instruction. On the contrary, the second correspondence relationship information 83 cannot be rewritten with the contents shown in FIG. 13. The first correspondence relationship information 82 and the second correspondence relationship information 83 may be integrated into one piece of correspondence relationship information.

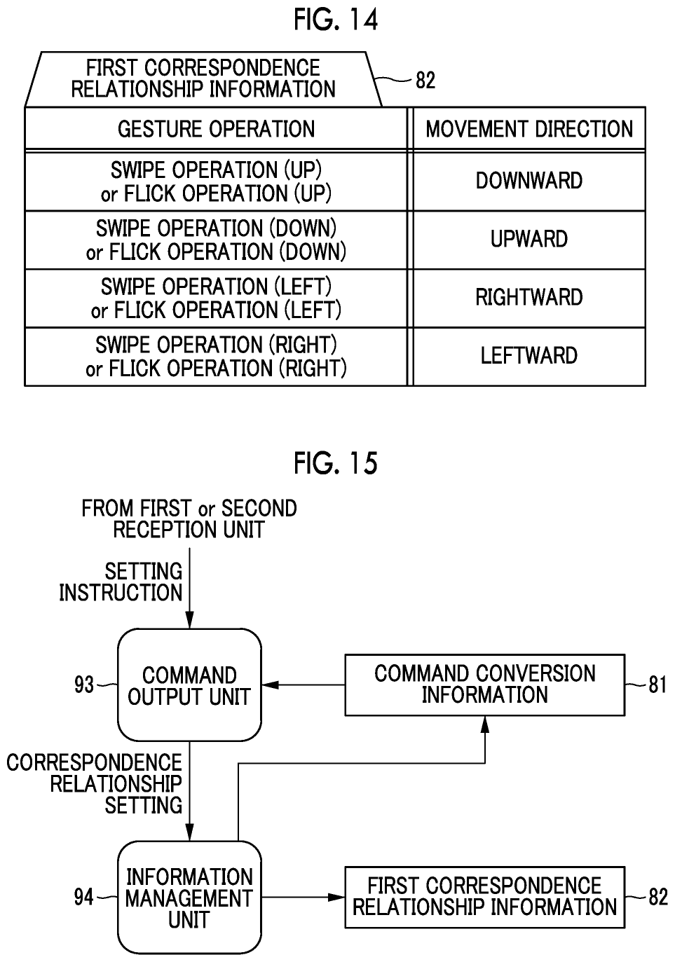

FIG. 14 is another example of the first correspondence relationship information 82. In FIG. 12, the operation direction of the swipe operation or the flick operation matches the movement direction of the enlargement display region 35. However, in the example shown in FIG. 14, the operation direction of the swipe operation or the flick operation is different from the movement direction of the enlargement display region 35. That is, the movement direction of the enlargement display region 35 is set to down for the upward swipe and flick operations and the movement direction of the enlargement display region 35 is set to up for the downward swipe and flick operations, respectively. The movement direction of the enlargement display region 35 is set to right for the leftward swipe and flick operations and the movement direction of the enlargement display region 35 is set to left for the rightward swipe and flick operations, respectively.

In the first correspondence relationship information shown in FIG. 14, the operation direction of the swipe operation or the flick operation and the movement direction of the enlargement display region 35 are all reversed. Although there is an uncomfortable feeling at first glance, it makes sense in a case where the operation direction of the swipe operation or the flick operation is replaced with the movement direction of the region of the captured image. For example, in the case of the upward swipe operation or flick operation, the uncomfortable feeling is reduced in a case where it is considered that the movement direction of the region of the captured image is upward and the enlargement display region 35 is relatively moved downward.

As shown in FIG. 15, the command output unit 93 outputs the command to set the first correspondence relationship to the information management unit 94 in response to the setting instruction from the first reception unit 90 or the second reception unit 91. The information management unit 94 registers the first correspondence relationship in the first correspondence relationship information 82 in response to the command. The information management unit 94 registers the command of a portion 100A (refer to FIG. 11) of the swipe operation or the flick operation of the command conversion information 81 based on the first correspondence relationship information 82. Accordingly, the first correspondence relationship is set. That is, the information management unit 94 corresponds a setting unit that sets a correspondence relationship between the operation direction of the gesture operation and the movement direction of the enlargement display region 35 in response to the setting instruction received by the first reception unit 90 or the second reception unit 91, and has a setting function. For a portion 100B of the operation of the direction instruction key 22 (refer to FIG. 11), a command based on the second correspondence relationship information 83 is registered in advance.

The setting instruction is actually recognized by the recognition unit 92 and the recognition result is output to the command output unit 93. However, the setting instruction is assumed to be output from the first reception unit 90 to the command output unit 93 in FIG. 15 for simplifying a description.

In a case where the gesture operation or the key operation is performed, the command output unit 93 decides the movement direction of the enlargement display region 35 in the region of the captured image based on the first correspondence relationship or the second correspondence relationship. That is, the command output unit 93 corresponds to a deciding unit and has a deciding function. The command output unit 93 outputs a command to move the enlargement display region 35 in the decided movement direction to the display control unit 95. The display control unit 95 moves the enlargement display region 35 in the movement direction indicated by the command.

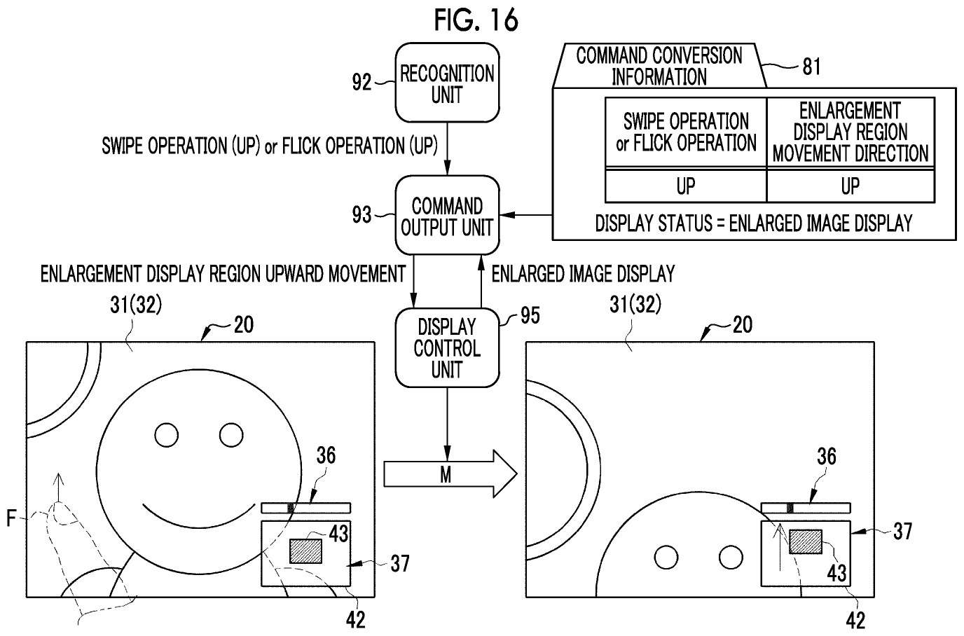

FIG. 16 shows the first correspondence relationship information 82 shown in FIG. 12 and shows a case where the upward swipe operation or flick operation is performed as the gesture operation in a display status where the enlarged image is displayed. In this case, the command output unit 93 refers to the command conversion information 81 generated by the portion 100A based on the first correspondence relationship information 82 to output the command to move the enlargement display region 35 upward to the display control unit 95. The display control unit 95 moves the enlargement display region 35 upward in response to the command.

The enlargement display region 35 is a region where the entire face of the person appears in the center, for example, shown in FIG. 5B as shown on a left side of an arrow M, before the upward swipe operation or the flick operation is performed. In a case where the upward swipe operation or flick operation is performed from this state, the enlargement display region 35 is moved upward as shown on a right side of the arrow M and becomes, for example, an upper half region of the face of the person. Further, the inner frame 43 of the guide frame 37 is moved upward accompanying the movement of the enlargement display region 35. In a case where the downward, leftward, and rightward swipe operation or flick operation are performed, the movement directions of the enlargement display region 35 are simply the downward, leftward, and rightward directions, respectively, and thus illustration and description thereof are omitted.

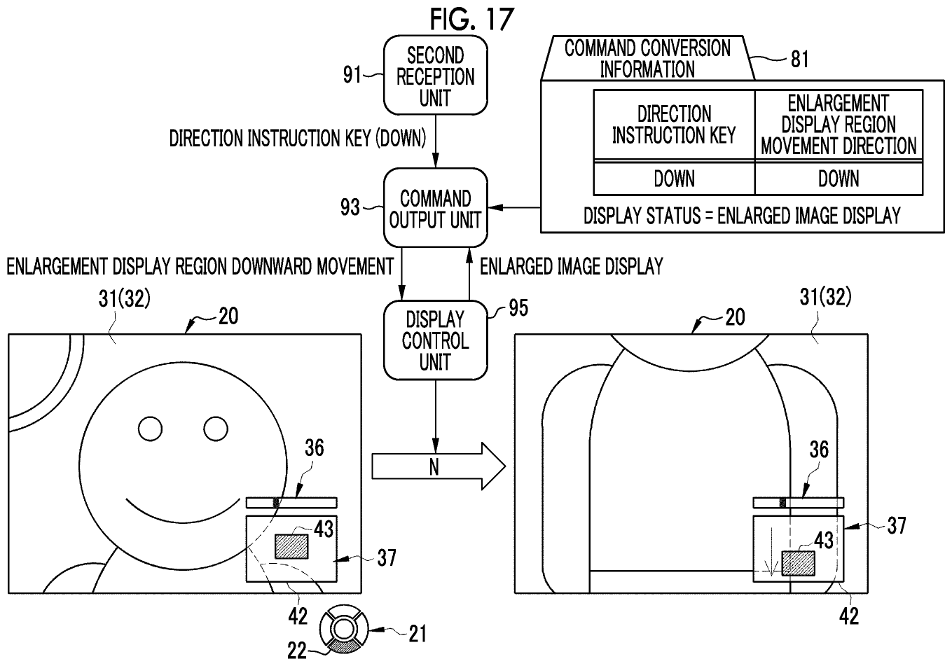

On the other hand, FIG. 17 shows a case where the downward operation of the direction instruction key 22 is performed as the key operation in a display status where the enlarged image is displayed. In this case, the command output unit 93 outputs a command to move the enlargement display region 35 downward to the display control unit 95. The display control unit 95 moves the enlargement display region 35 downward in response to the command.

The left side of an arrow N is a state in which the region where the entire face of the person appears in the center is the enlargement display region 35, similar to the left side of the arrow M in FIG. 16. In a case where the downward operation of the direction instruction key 22 is performed from this state, the enlargement display region 35 is moved downward as shown on the right side of the arrow N and becomes a region where the upper body excluding the face of the person appears, for example. The inner frame 43 of the guide frame 37 is moved downward accompanying the movement of the enlargement display region 35. In a case where the upward, leftward, and rightward operations of the direction instruction key 22 are performed, the movement directions of the enlargement display region 35 are simply the upward, leftward, and rightward directions, respectively, and thus illustration and description thereof are omitted.

The second correspondence relationship in which the operation direction of the direction instruction key 22 matches the movement direction of the enlargement display region 35 is registered in the second correspondence relationship information 83 shown in FIG. 13. Therefore, the display control unit 95 moves the enlargement display region 35 in a direction that matches the direction as instructed by the direction instruction key 22. Further, the display control unit 95 fixes the display position of the outer frame 42 in the screen 32 and moves the inner frame 43 with respect to the outer frame 42 according to the movement of the enlargement display region 35. Hereinafter, a display type of the guide frame 37 is referred to as an inner frame movement type.

A movement amount of the enlargement display region 35 depends on a movement amount and a movement speed of the finger F. The movement amount of the enlargement display region 35 becomes larger as the movement amount of the finger F is large and the movement speed thereof is high.

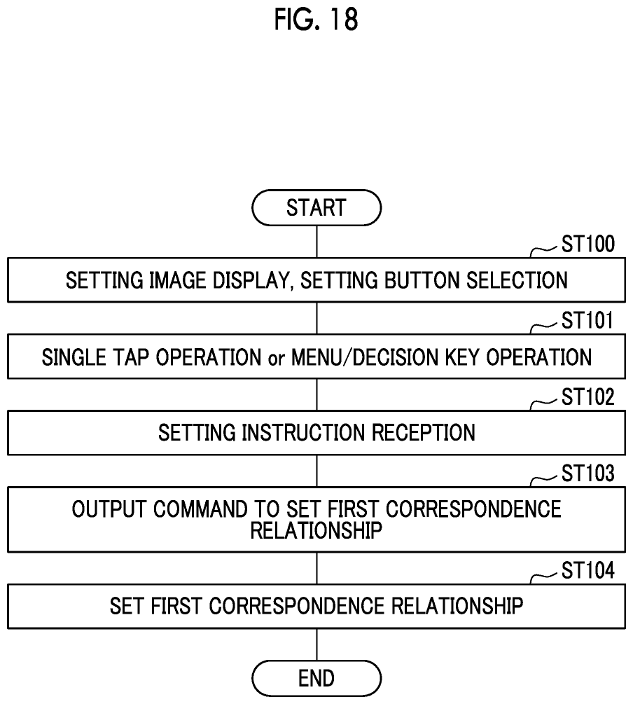

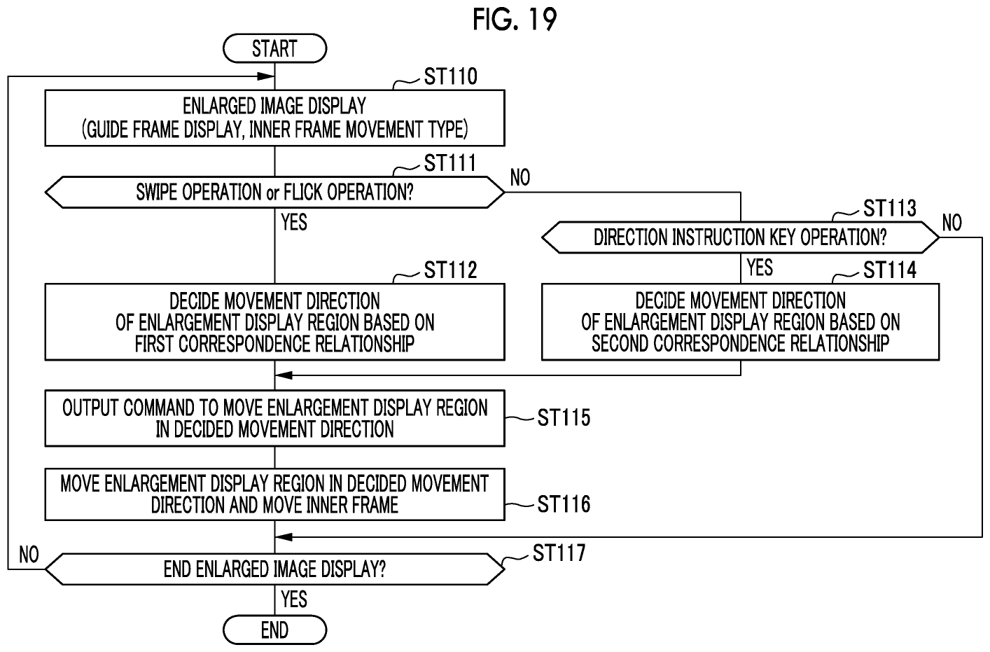

Next, an action by the above configuration will be described with reference to flowcharts of FIGS. 18 and 19. First, as shown in FIG. 18, in a case where the single tap operation or the menu/decision key 23 is operated (step ST101) in a display status where the setting button 52 is selected in the setting image 50 (step ST100), the first reception unit 90 or the second reception unit 91 receives the setting instruction (step ST102, reception step).

As shown in FIG. 15, the setting instruction is output from the first reception unit 90 or the second reception unit 91 to the command output unit 93. In response to this setting instruction, the command to set the first correspondence relationship is output from the command output unit 93 to the information management unit 94 (step ST103). The information management unit 94 that receives the command to set the first correspondence relationship registers the first correspondence relationship in the first correspondence relationship information 82. The command of the portion 100A of the swipe operation or the flick operation of the command conversion information 81 is registered based on the first correspondence relationship information 82. Accordingly, the first correspondence relationship is set (step ST104, setting step).

In a case where the reproduction display key 24 is operated, the display control unit 95 reproduces and displays the captured image on the screen 32 as shown in FIG. 5A. In a case where the pinch-out operation is performed on the touch-type operation unit 31, the display control unit 95 displays the enlarged image on the screen 32 as shown in FIG. 5B.

As shown in FIG. 19, in a case where the swipe operation or the flick operation is performed on touch-type operation unit 31 (YES in step ST111) in the display status where the enlarged image is displayed (step ST110, the guide frame 37 is also displayed by the inner frame movement type), the command output unit 93 decides the movement direction of the enlargement display region 35 based on the first correspondence relationship (step ST112, deciding step) as shown in FIG. 16.

On the other hand, in a case where the direction instruction key 22 is operated instead of the swipe operation or the flick operation (NO in step ST111, YES in step ST113), the command output unit 93 decides the movement direction of the enlargement display region 35 based on the second correspondence relationship as shown in FIG. 17 (step ST114).

After the movement direction of the enlargement display region 35 is decided, the command to move the enlargement display region 35 in the decided movement direction is output from the command output unit 93 to the display control unit 95 (step ST115). As shown on the right side of the arrow M in FIG. 16 and on the right side of the arrow N in FIG. 17, the display control unit 95 moves the enlargement display region 35 in the decided movement direction and the inner frame 43 is moved (step ST116, display control step).

The processing shown in steps ST110 to ST116 is repeatedly executed until the return key 25 is operated to end the display of the enlarged image (YES in step ST117).

In a case where the first correspondence relationship is set and the swipe operation or the flick operation is performed, the movement direction of the enlargement display region 35 is decided based on the set first correspondence relationship and the enlargement display region 35 is moved in the decided movement direction. Therefore, it is possible to set the first correspondence relationship according to the preference of the user, for example, the same first correspondence relationship as a digital camera to which the user is accustomed, and to move the list image 35 based on the first correspondence relationship.

The first correspondence relationship cannot be set and is fixed in the related art, and a user who feels uncomfortable in an initial operation with the fixed setting is required to perform the operation while dragging the uncomfortable feeling until the user is accustomed to the operation. On the contrary, according to the present invention, it is possible for the user to freely set the preferred first correspondence relationship and thus to perform the operation without feeling uncomfortable from the initial operation.

The display control unit 95 moves the enlargement display region 35 in the direction that matches the direction as instructed by the direction instruction key 22, fixes the display position of the outer frame 42 in the screen 32, and moves the inner frame 43 with respect to the outer frame 42 according to the movement of the enlargement display region 35. Therefore, it is possible to move the enlargement display region 35 in a more intuitive and easily understandable movement direction with respect to the operation direction of the direction instruction key 22 having a shape and operation feeling that can be tactilely perceived such as an uneven shape, unlike the touch-type operation unit 31.

### Second Embodiment

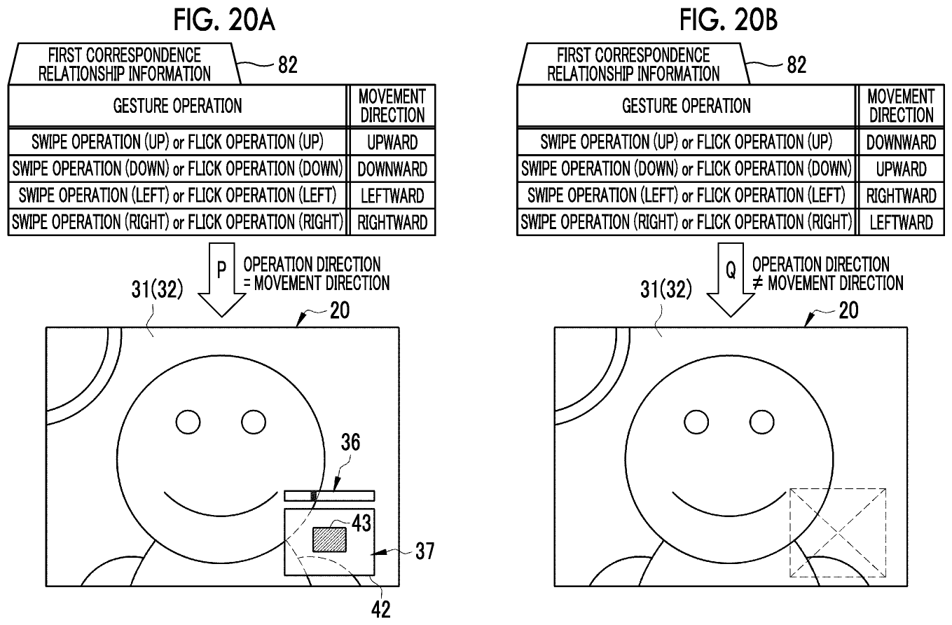

In a second embodiment shown in FIGS. 20 to 25, the display and the non-display of the guide frame 37 are switched according to the first correspondence relationship. In the following, description will be made focusing on differences from the first embodiment, and description of the same configuration and action as those of the first embodiment will be omitted. The following embodiments are also the same.

The first correspondence relationship information 82 shown in FIG. 20A is the same as that shown in FIG. 12 and is the case where the operation direction of the swipe operation or the flick operation matches the movement direction of the enlargement display region 35. In this case, the display control unit 95 displays the guide frame 37 on the screen 32 as in the first embodiment, as shown below an arrow P.

On the other hand, the first correspondence relationship information 82 shown in FIG. 20B is the same as that shown in FIG. 14 and is the case where the operation direction of the swipe operation or the flick operation is different from the movement direction of the enlargement display region 35. In this case, the display control unit 95 does not display the guide frame 37 as indicated by a broken line frame and an X mark shown below an arrow Q. Here, the enlargement ratio display bar 36 is also not displayed in addition to the guide frame 37.

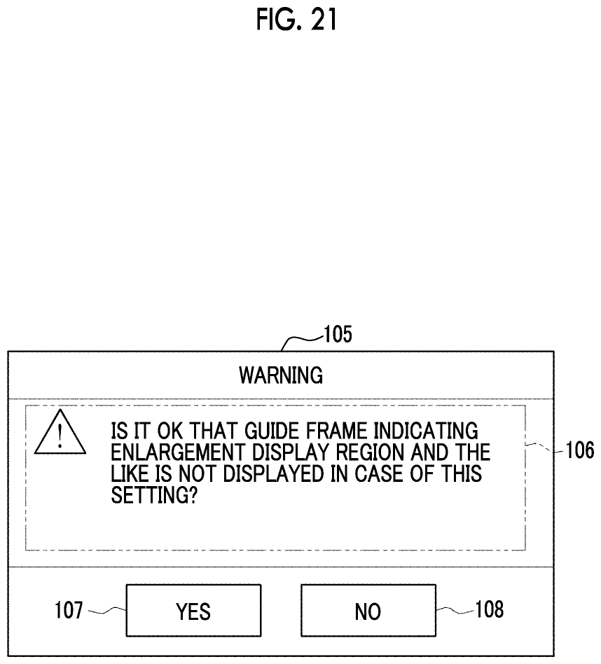

In a case where the operation direction of the swipe operation or the flick operation is differently set from the movement direction of the enlargement display region 35 in the setting image 50 and the setting button 52 is selected, the display control unit 95 displays a first warning image 105 shown in FIG. 21 on the screen 32.

In FIG. 21, a message 106 inquiring whether or not the non-display of the guide frame 37 and the like is allowed is displayed on the first warning image 105, and further, a Yes button 107 and a No button 108 are provided. In a case where the Yes button 107 is selected, the same processing as in the case where the setting button 52 is selected is executed. On the other hand, in a case where the No button 108 is selected, the first warning image 105 is deleted from the screen 32 and the display is returned to the setting image 50.

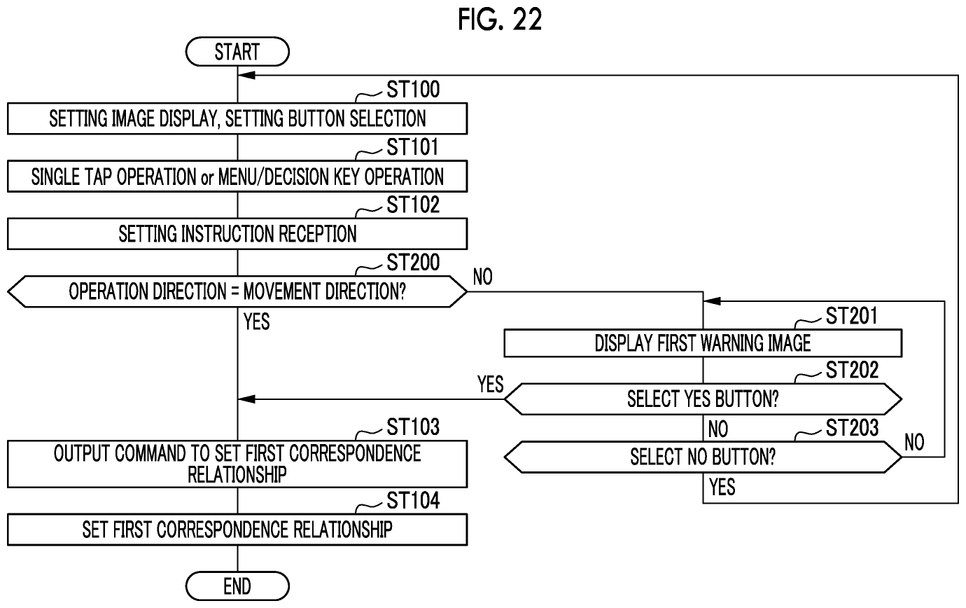

FIGS. 22 to 24 are flowcharts showing a processing procedure of a digital camera in the present embodiment. First, as shown in FIG. 22, in a case where the first reception unit 90 or the second reception unit 91 receives a setting instruction (step ST102, reception step), the command output unit 93 determines whether or not a first correspondence relationship represented by the setting instruction is the first correspondence relationship in which the operation direction of the swipe operation or the flick operation matches the movement direction of the enlargement display region 35 (step ST200).

In a case where the operation direction of the swipe operation or the flick operation matches the movement direction of the enlargement display region 35 (YES in step ST200), the command to set the first correspondence relationship is output from the command output unit 93 to the information management unit 94 (step ST103). Subsequent processing is the same as in the first embodiment.

On the other hand, in a case where the operation direction of the swipe operation or the flick operation is different from the movement direction of the enlargement display region 35 (NO in step ST200), a command to display the first warning image 105 on the screen 32 is output from the command output unit 93 to the display control unit 95. Accordingly, the first warning image 105 is displayed on the screen 32 (step ST201).

In a case where the Yes button 107 of the first warning image 105 is selected (YES in step ST202), the command to set the first correspondence relationship is output from the command output unit 93 to the information management unit 94, similar to the case where the operation direction of the swipe operation or the flick operation matches the movement direction of the enlargement display region 35 (step ST103). On the other hand, in a case where the No button 108 is selected (NO in step ST202, YES in step ST203), the processing returns to step ST100.

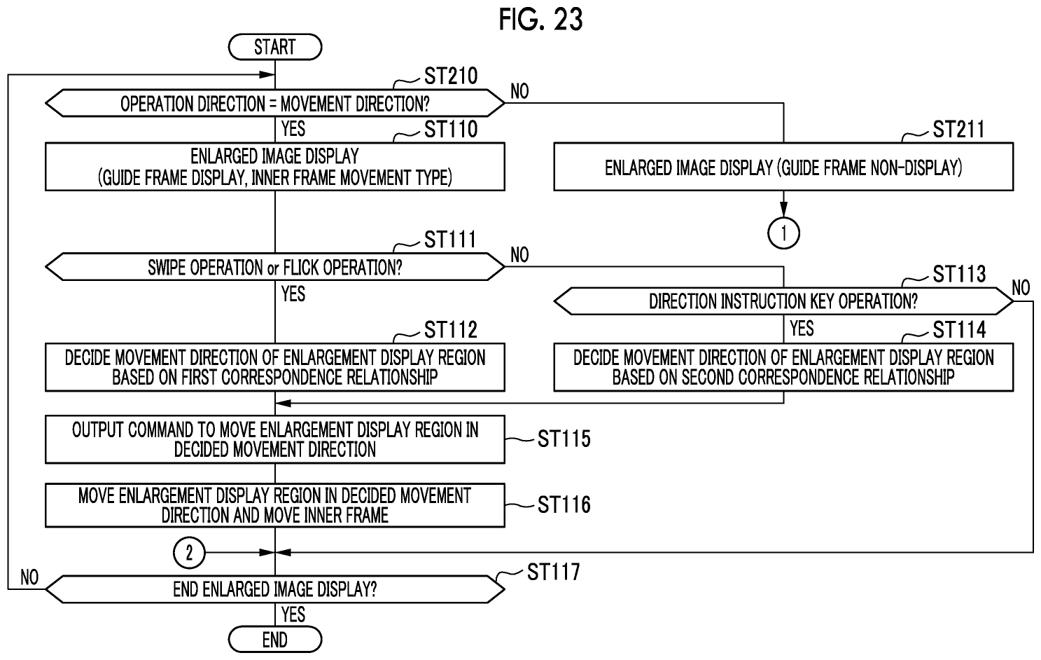

As shown in FIG. 23, in a case where the enlarged image is displayed on the screen 32, the command output unit 93 determines whether or not the first correspondence relationship is the first correspondence relationship in which the operation direction of the swipe operation or the flick operation matches the movement direction of the enlargement display region 35 (step ST210), as in step ST200 of FIG. 22.

In the case where the operation direction of the swipe operation or the flick operation matches the movement direction of the enlargement display region 35 (YES in step ST210), a command to display the enlarged image and the guide frame 37 of the inner frame movement type on the screen 32 is output from the command output unit 93 to the display control unit 95. Accordingly, the enlarged image and the guide frame 37 of the inner frame movement type are displayed on the screen 32 (step ST110). That is, it is the same as the first embodiment.

On the other hand, in the case where the operation direction of the swipe operation or the flick operation is different from the movement direction of the enlargement display region 35 (NO in step ST210), a command to perform the non-display of the enlargement ratio display bar 36 and the guide frame 37 and the display of only the enlarged image on the screen 32 is output from the command output unit 93 to the display control unit 95. Accordingly, only the enlarged image is displayed on screen 32 (step ST211).

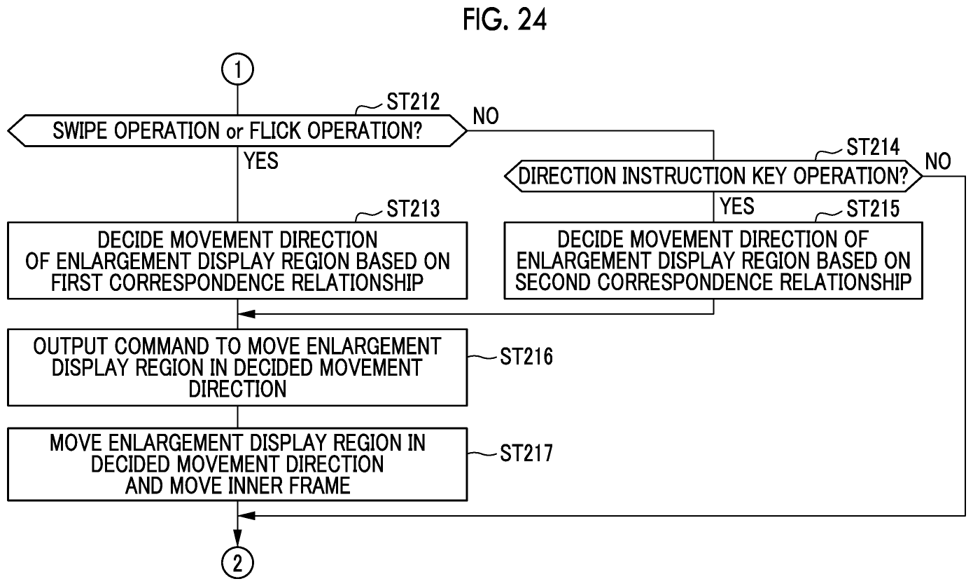

As shown in FIG. 24, in a case where the swipe operation or the flick operation is performed on touch-type operation unit 31 (YES in step ST212) in a display status where only the enlarged image is displayed (step ST211), the command output unit 93 decides the movement direction of the enlargement display region 35 based on the first correspondence relationship (step ST213, deciding step).

On the other hand, in a case where the direction instruction key 22 is operated instead of the swipe operation or the flick operation (NO in step ST212, YES in step ST214), the command output unit 93 decides the movement direction of the enlargement display region 35 based on the second correspondence relationship (step ST215).

After the movement direction of the enlargement display region 35 is decided, the command to move the enlargement display region 35 in the decided movement direction is output from the command output unit 93 to the display control unit 95 (step ST216). The display control unit 95 moves the enlargement display region 35 in the decided movement direction (step ST217, display control step). At this time, the inner frame 43 is not moved since the guide frame 37 is not displayed.

As described above, in a case of the first correspondence relationship in which the operation direction of the swipe operation or the flick operation is different from the movement direction of the enlargement display region 35, the guide frame 37 is not displayed. Therefore, the user does not feel the uncomfortable feeling caused by the movement of the inner frame 43 linked with the movement of the enlargement display region 35 in a reverse direction with respect to the operation direction of the swipe operation or the flick operation.

In a case where the guide frame 37 is not displayed, the first warning image 105 for inquiring whether or not the non-display of the guide frame 37 is allowed is displayed on the screen 32. Therefore, it is possible to perform the non-display of the guide frame 37 with the confirmation of the intention of the user and to avoid as much as possible a situation in which the guide frame 37 is not displayed unintentionally due to a setting error.

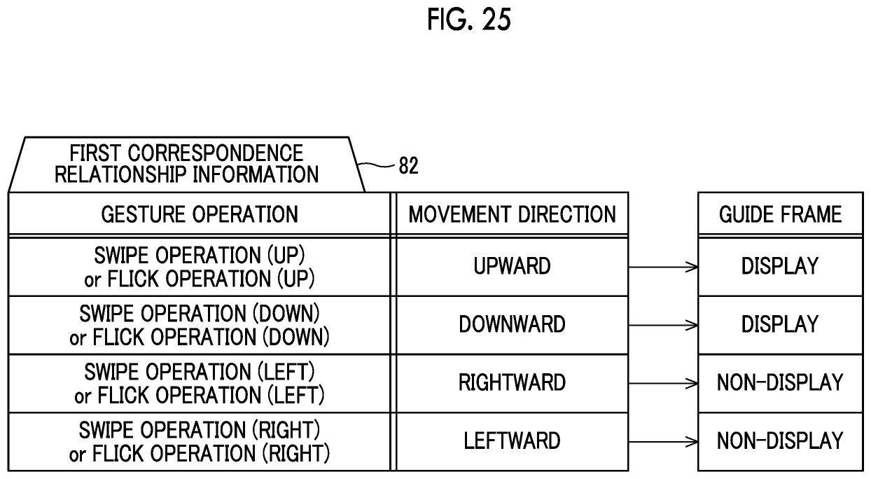

FIG. 20A shows a case where the operation direction of the swipe operation or the flick operation and the movement direction of the enlargement display region 35 are all the same in the up, down, left, and right directions, and FIG. 20B shows a case where the operation direction of the swipe operation or the flick operation and the movement direction of the enlargement display region 35 are all different in the up, down, left, and right directions. However, as shown in FIG. 25, it is considered a case where the operation direction of the swipe operation or the flick operation and the movement direction of the enlargement display region 35 partially match and partially differ. In this case, the display or non-display of the guide frame 37 is switched according to the operation direction of the swipe operation or the flick operation.

More specifically, in the case of the swipe operation or flick operation in the up-down direction, the guide frame 37 is displayed since the movement direction of the enlargement display region 35 matches the operation direction thereof. On the contrary, in the case of the swipe operation or flick operation in the left-right direction, the guide frame 37 is not displayed since the movement direction of the enlargement display region 35 is different from the operation direction thereof.

There may be a user who is accustomed to the first correspondence relationship in which the operation direction of the swipe operation or the flick operation is different from the movement direction of the enlargement display region 35. In a case where the guide frame 37 is displayed in a case of the first correspondence relationship in which the operation direction of the swipe operation or the flick operation matches the movement direction of the enlargement display region 35, such a user may feel uncomfortable instead. Therefore, contrary to the above, the guide frame 37 may not be displayed in the case of the first correspondence relationship in which the operation direction of the swipe operation or the flick operation matches the movement direction of the enlargement display region 35.

### Third Embodiment

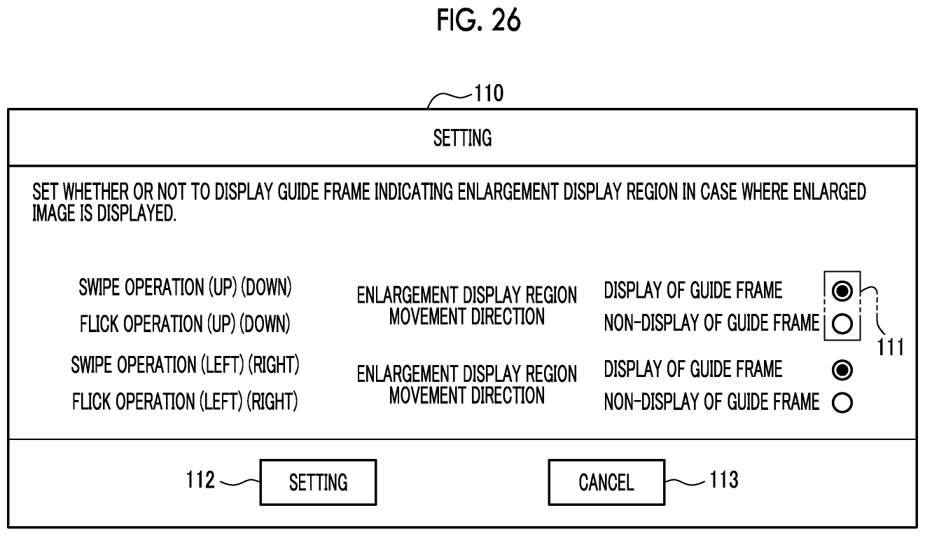

In a third embodiment shown in FIGS. 26 to 29, the first reception unit 90 or the second reception unit 91 receives the instruction to perform the display and the non-display of the guide frame 37 (hereinafter referred to as display setting instruction) and switches between the display and the non-display of the guide frame 37 according to the display setting instruction.

In the present embodiment, the display control unit 95 displays a display setting image 110 shown in FIG. 26 on the screen 32 instead of the setting image 50 shown in FIG. 7 of the first embodiment. The display setting image 110 is provided with a radio button 111 for selectively setting any one of the display or non-display of the guide frame 37 for the swipe operation or the flick operation in the up-down direction and the left-right direction, respectively, and a setting button 112 and a cancel button 113.

The setting button 112 and the cancel button 113 can be selected by the single tap operation or the menu/decision key 23, similar to the setting button 52 and the cancel button 53 of the setting image 50. In a case where the setting button 112 is selected, the first correspondence relationship is set based on a selected state of the radio button 111 at the time. In FIG. 26, the setting to display the guide frame 37 is performed for the swipe operation or the flick operation in both the up-down direction and the left-right direction. On the other hand, in a case where the cancel button 113 is selected, the display setting image 110 is deleted from the screen 32.

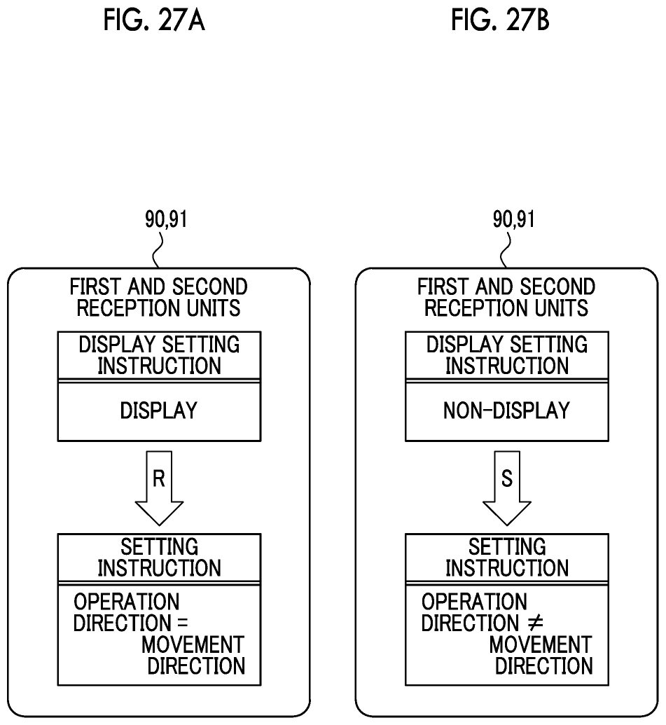

In FIG. 27, the first reception unit 90 or the second reception unit 91 receives the display setting instruction. In a case where the display setting instruction is to perform the display of the guide frame 37 as shown in FIG. 27A, the first reception unit 90 or the second reception unit 91 receives the instruction as the setting instruction for the first correspondence relationship in which the operation direction of the swipe operation or the flick operation matches the movement direction of the enlargement display region 35, as shown below an arrow R. On the contrary, as shown in FIG. 27B, in a case where the display setting instruction is to perform the non-display of the guide frame 37, the first reception unit 90 or the second reception unit 91 receives the instruction as the setting instruction for the first correspondence relationship in which the operation direction of the swipe operation or the flick operation is different from the movement direction of the enlargement display region 35, as shown below an arrow S.

Also in the present embodiment, in a case where the display setting instruction is the non-display, the display control unit 95 displays the first warning image 105 shown in FIG. 21 of the second embodiment on the screen 32.

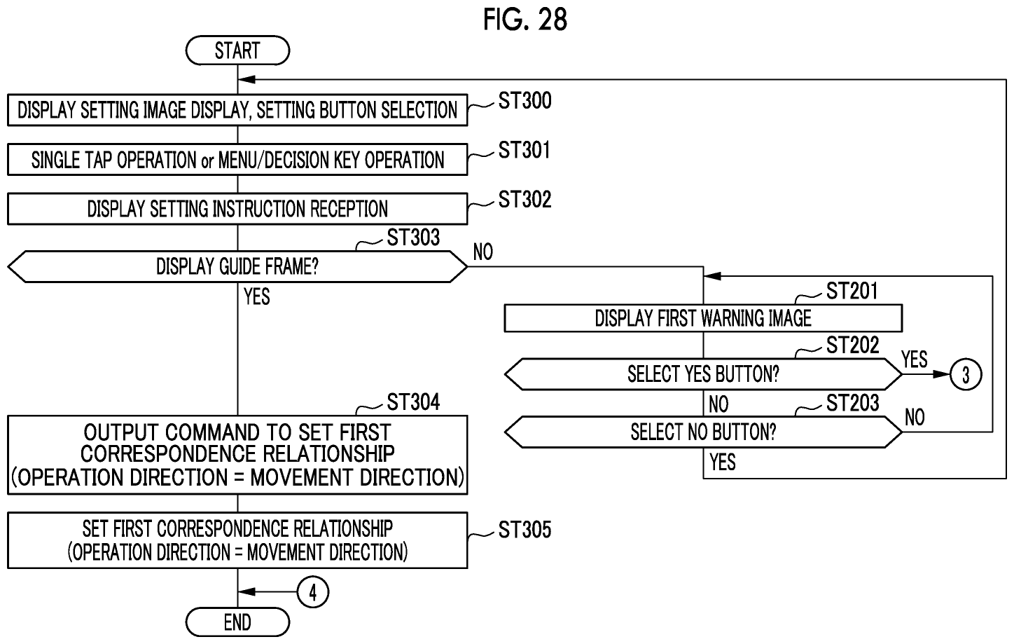

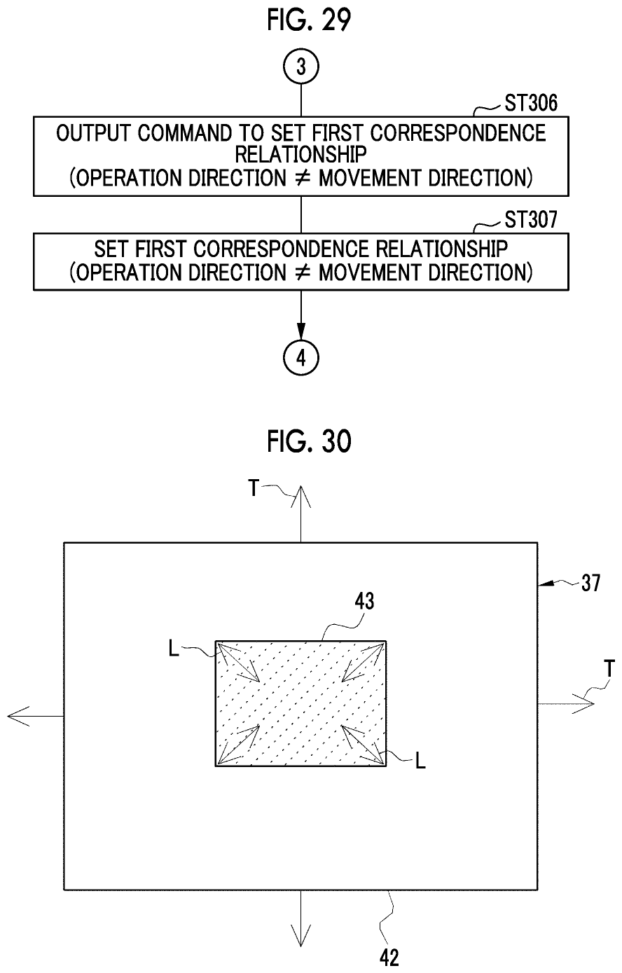

FIGS. 28 and 29 are flowcharts showing a processing procedure of a digital camera in the present embodiment. First, the display control unit 95 displays the display setting image 110 on the screen 32, as shown in step ST300 of FIG. 28. In a case where the single tap operation or the menu/decision key 23 is operated (step ST301) in a display status where the setting button 112 is selected in the display setting image 110, the first reception unit 90 or the second reception unit 91 receives the display setting instruction (step ST302, reception step).

In a case where the first reception unit 90 or the second reception unit 91 receives the display setting instruction, the command output unit 93 determines whether or not the display setting instruction is to perform the display or non-display of the guide frame 37 (step ST303).

In a case where the display setting instruction is to perform the display of the guide frame 37 (YES in step ST303), the command to set the first correspondence relationship in which the operation direction of the swipe operation or the flick operation matches the movement direction of the enlargement display region 35 is output from the command output unit 93 to the information management unit 94 (step ST304). The information management unit 94 that receives the command to set the first correspondence relationship registers the first correspondence relationship in the first correspondence relationship information 82. The command of the portion 100A of the swipe operation or the flick operation of the command conversion information 81 is registered based on the first correspondence relationship information 82. Accordingly, the first correspondence relationship in which the operation direction of the swipe operation or the flick operation matches the movement direction of the enlargement display region 35 is set (step ST305, setting step).

On the other hand, in a case where the display setting instruction is to perform the non-display of guide frame 37 (NO in step ST303), the command to display the first warning image 105 shown in FIG. 21 on the screen 32 is output from the command output unit 93 to the display control unit 95. Accordingly, the first warning image 105 is displayed on the screen 32 (step ST201).

In a case where the Yes button 107 of the first warning image 105 is selected (YES in step ST202), the command to set the first correspondence relationship in which the operation direction of the swipe operation or the flick operation is different from the movement direction of the enlargement display region 35 is output from the command output unit 93 to the information management unit 94 (step ST306), as shown in FIG. 29. The information management unit 94 that receives the command to set the first correspondence relationship registers the first correspondence relationship in the first correspondence relationship information 82. The command of the portion 100A of the swipe operation or the flick operation of the command conversion information 81 is registered based on the first correspondence relationship information 82. Accordingly, the first correspondence relationship in which the operation direction of the swipe operation or the flick operation is different from the movement direction of the enlargement display region 35 is set (step ST307, setting step).

On the other hand, in a case where the No button 108 is selected (NO in step ST202, YES in step ST203), the processing returns to step ST300. The processing procedure in the case where the enlarged image is displayed on the screen 32 is the same as that shown in FIGS. 23 and 24 of the second embodiment, and thus illustration and description thereof are omitted.

As described above, the first reception unit 90 or the second reception unit 91 receives the instruction to perform the non-display of the guide frame 37 as the setting instruction for the correspondence relationship in which the operation direction of the swipe operation or the flick operation is different from the movement direction of the enlargement display region 35. Therefore, the user does not feel the uncomfortable feeling caused by the movement of the inner frame 43 linked with the movement of the enlargement display region 35 in a reverse direction with respect to the operation direction of the swipe operation or the flick operation, as in the second embodiment.

In order to correspond to the user who is accustomed to the first correspondence relationship in which the operation direction of the swipe operation or the flick operation is different from the movement direction of the enlargement display region 35 as in the second embodiment, the first reception unit 90 or the second reception unit 91 may receive the instruction to perform the non-display of the guide frame 37 conversely as the setting instruction for the correspondence relationship in which the operation direction of the swipe operation or the flick operation matches the movement direction of the enlargement display region 35.

### Fourth Embodiment

In a fourth embodiment shown in FIGS. 30 to 33, the display of the guide frame 37 is switched between the inner frame movement type and an outer frame movement type according to the first correspondence relationship.

The inner frame movement type is a type in which the display position of the outer frame 42 in the screen 32 is fixed and the inner frame 43 is moved with respect to the outer frame 42 according to the movement of the enlargement display region 35, as indicated by an arrow K in FIG. 6. On the other hand, the outer frame movement type is a type in which the display position of the inner frame 43 in the screen 32 is fixed, and the outer frame 42 is moved with respect to the inner frame 43 according to the movement of the enlargement display region 35, as indicated by an arrow T in FIG. 30. In the outer frame movement type, in a case where the enlargement display region 35 moves, for example, upward, the outer frame 42 is conversely moved downward. The size of the inner frame 43 is changed according to the change in the enlargement ratio also in the outer frame movement type, similar to the inner frame movement type.

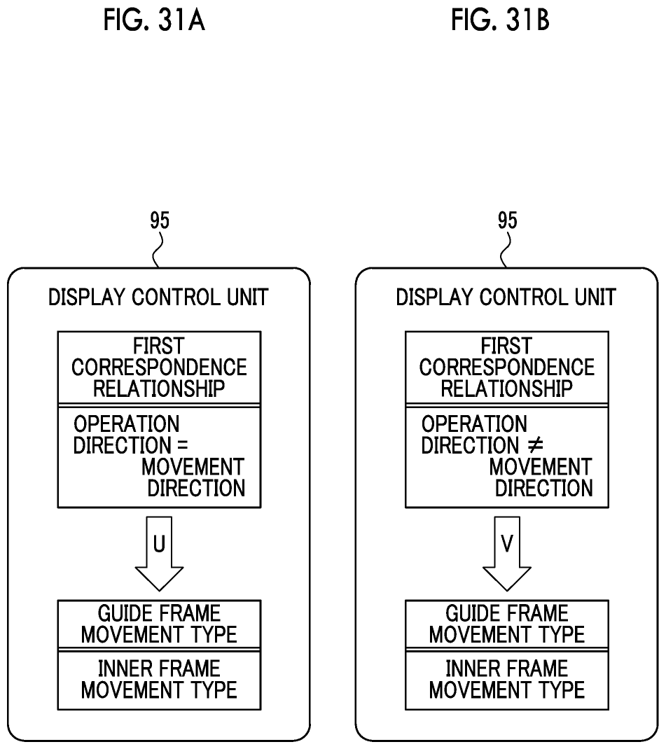

As shown in FIG. 31A, in a case of the first correspondence relationship in which the operation direction of the swipe operation or the flick operation matches the movement direction of the enlargement display region 35, the display control unit 95 sets the display type of the guide frame 37 as the inner frame movement type, as shown below an arrow U. On the other hand, as shown in FIG. 31B, in a case of the first correspondence relationship in which the operation direction of the swipe operation or the flick operation is different from the movement direction of the enlargement display region 35, the display control unit 95 sets the display type of the guide frame 37 as the outer frame movement type, as shown below an arrow V.

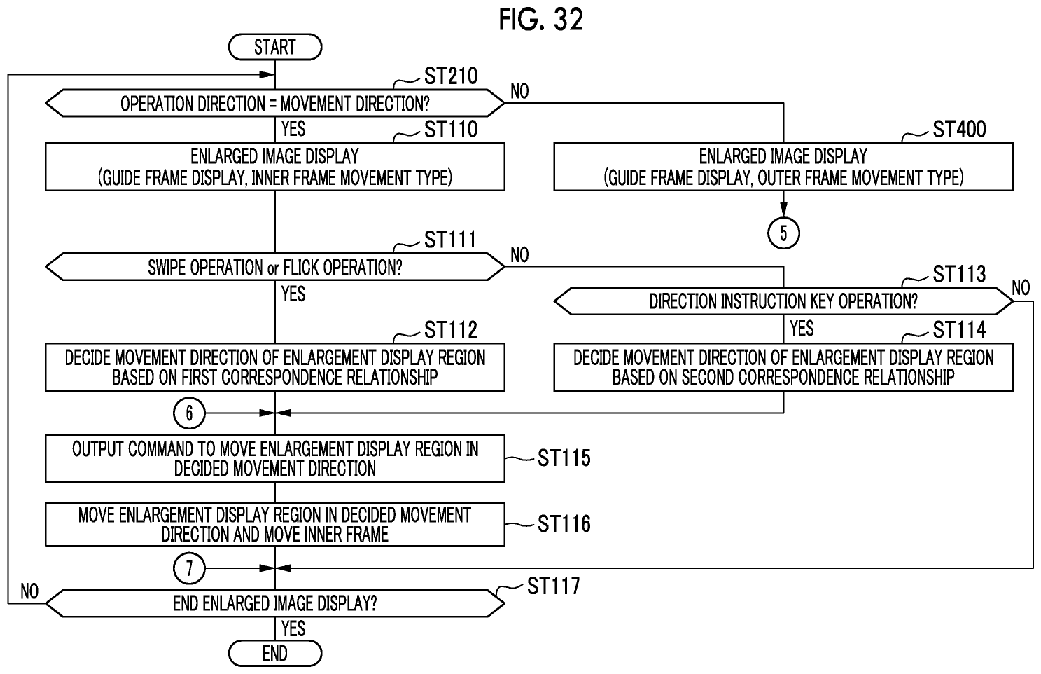

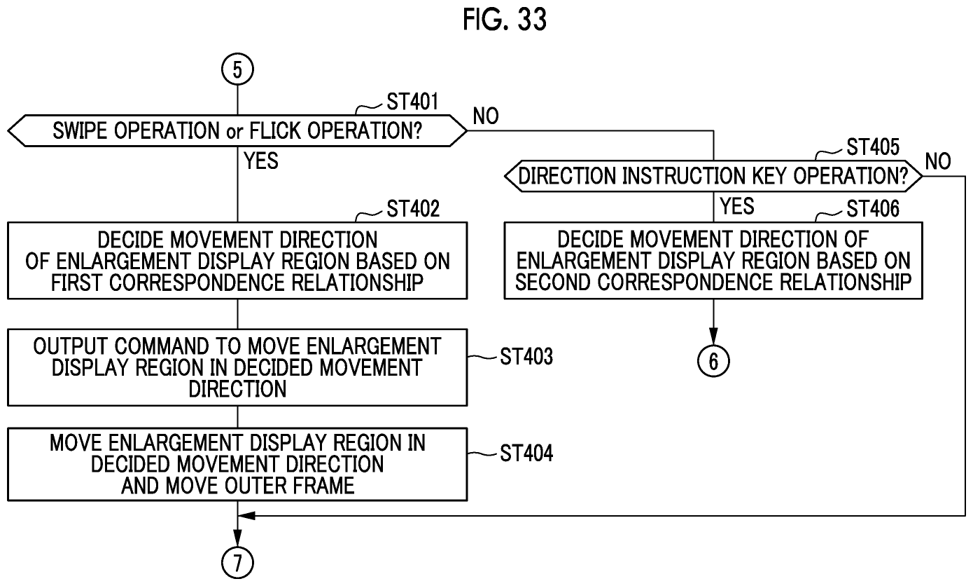

FIGS. 32 and 33 are flowcharts showing a processing procedure of a digital camera in the present embodiment. As shown in FIG. 32, in the case where the enlarged image is displayed on the screen 32, the command output unit 93 determines whether or not the first correspondence relationship is the first correspondence relationship in which the operation direction of the swipe operation or the flick operation matches the movement direction of the enlargement display region 35 (step ST210), as in FIG. 23 of the second embodiment.

In the case where the operation direction of the swipe operation or the flick operation matches the movement direction of the enlargement display region 35 (YES in step ST210), the command to display the enlarged image and the guide frame 37 of the inner frame movement type on the screen 32 is output from the command output unit 93 to the display control unit 95. Accordingly, the enlarged image and the guide frame 37 of the inner frame movement type are displayed on the screen 32 (step ST110). That is, it is the same as the first embodiment.

On the other hand, in the case where the operation direction of the swipe operation or the flick operation is different from the movement direction of the enlargement display region 35 (NO in step ST210), the command to display the enlarged image and the guide frame 37 of the outer frame movement type on the screen 32 is output from the command output unit 93 to the display control unit 95. Accordingly, the enlarged image and the guide frame 37 of the outer frame movement type are displayed on the screen 32 (step ST400).

In a case where the swipe operation or the flick operation is performed on the touch-type operation unit 31 (YES in step ST401) as shown in FIG. 33 in a display status in which the enlarged image and the guide frame 37 of the outer frame movement type are displayed (step ST400), the command output unit 93 decides the movement direction of the enlargement display region 35 based on the first correspondence relationship (step ST402, deciding step).

After the movement direction of the enlargement display region 35 is decided, the command to move the enlargement display region 35 in the decided movement direction is output from the command output unit 93 to the display control unit 95 (step ST403). The display control unit 95 moves the enlargement display region 35 in the decided movement direction and moves the outer frame 42 (step ST404, display control step).

On the other hand, in a case where the direction instruction key 22 is operated instead of the swipe operation or the flick operation (NO in step ST401, YES in step ST405), the command output unit 93 decides the movement direction of the enlargement display region 35 based on the second correspondence relationship (step ST406). Subsequent processing is the same as that after step ST112.

As described above, in the case of the first correspondence relationship in which the operation direction of the swipe operation or the flick operation is different from the movement direction of the enlargement display region 35, the display type of the guide frame 37 is set to the outer frame movement type. Therefore, in a case where the display type of the guide frame 37 is set to the inner frame movement type, the user does not feel the uncomfortable feeling caused by the movement of the inner frame 43 linked with the movement of the enlargement display region 35 in a reverse direction with respect to the operation direction of the swipe operation or the flick operation. In the case where the display type of the guide frame 37 is set to the outer frame movement type, the operation direction of the swipe operation or the flick operation can be easily replaced with the movement direction of the region of the captured image in the head of user. Therefore, it is possible to further reduce the uncomfortable feeling given to the user.

In order to correspond to the user who is accustomed to the first correspondence relationship in which the operation direction of the swipe operation or the flick operation is different from the movement direction of the enlargement display region 35 as in the second and third embodiments, the display type of the guide frame 37 may be set conversely to the inner frame movement type in the case of the first correspondence relationship in which the operation direction of the swipe operation or the flick operation is different from the movement direction of the enlargement display region 35.

### Fifth Embodiment

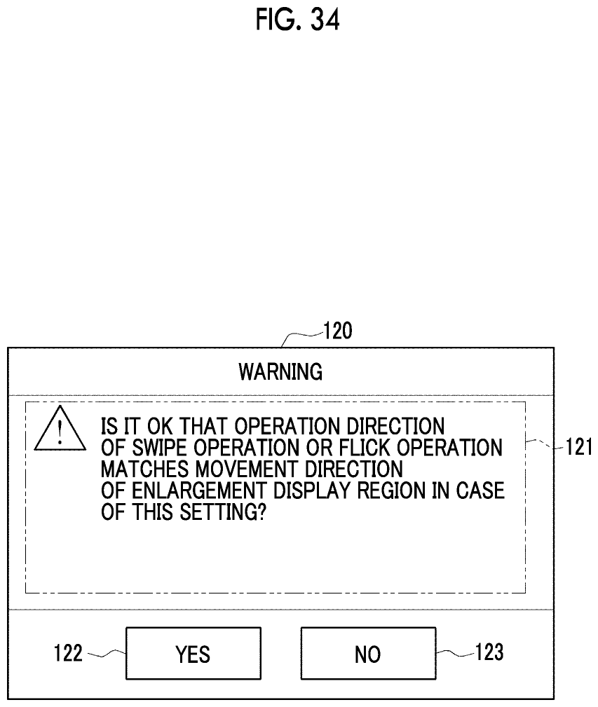

In a fifth embodiment shown in FIG. 34, the display control unit 95 displays a second warning image 120 for inquiring whether or not a setting in which the operation direction of the swipe operation or the flick operation matches the movement direction of the enlargement display region 35 is allowed is displayed on the screen 32.

In a case where the setting in which the operation direction of the swipe operation or the flick operation matches the movement direction of the enlargement display region 35 is set in the setting image 50 and the setting button 52 is selected, that is, in a case where the first reception unit 90 or the second reception unit 91 receives the setting instruction for the first correspondence relationship in which the operation direction of the swipe operation or the flick operation matches the movement direction of the enlargement display region 35, the display control unit 95 displays the second warning image 120 on the screen 32.

The second warning image 120 displays a message 121 for inquiring whether or not the setting in which the operation direction of the swipe operation or the flick operation matches the movement direction of the enlargement display region 35 is allowed and is further provided with a Yes button 122 and a No button 123. In a case where the Yes button 122 is selected, the same processing as in the case where the setting button 52 is selected is executed. On the other hand, in a case where the No button 123 is selected, the second warning image 120 is deleted from the screen 32 and the display is returned to the setting image 50. By doing so, it is possible to avoid the setting of the first correspondence relationship that is not intended by the user as much as possible.

In each of the above embodiments, the example in which the movement direction of the enlargement display region 35 with respect to the swipe operation or the flick operation in four directions of up, down, left, and right is set as the first correspondence relationship. However, four directions of diagonally upper left, diagonally upper right, diagonally lower left, and diagonally lower right may be further added. In this case, the direction instruction key 22 is also composed to be capable of performing an instruction for the respective directions of diagonally upper left, diagonally upper right, diagonally lower left, and diagonally lower right.

Not only the first correspondence relationship but also the second correspondence relationship may be settable.

In each of the above embodiments, for example, a hardware structure of a processing unit that executes various types of processing, such as the first reception unit 90 and the second reception unit 91 corresponding to the reception unit, the recognition unit 92, the command output unit 93 corresponding to the deciding unit, the information management unit 94 corresponding to the setting unit, and the display control unit 95, is various processors described below.

The various processors include a CPU, a programmable logic device (PLD), a dedicated electric circuit, and the like. The CPU is a general-purpose processor that executes software (program) and functions as various processing units as is well known. The PLD is a processor whose circuit configuration can be changed after manufacturing, such as a field programmable gate array (FPGA). The dedicated circuitry is a processor having a circuit configuration designed specially for executing specific processing, such as an application specific integrated circuit (ASIC).

One processing unit may be composed of one of these various processors or a combination of two or more processors having the same type or different types (for example, combination of a plurality of FPGAs, or CPU and FPGA). A plurality of processing units may be composed of one processor. As an example of composing the plurality of processing units with one processor, first, there is a form in which one processor is composed of a combination of one or more CPUs and software and the processor functions as the plurality of processing units. Second, there is a form of using a processor realizing the functions of the entire system including the plurality of processing units with one IC chip, as represented by a system on chip (SoC) or the like. As described above, the various processing units are composed of one or more of the various processors described above as the hardware structure.

Further, the hardware structure of these various processors is, more specifically, a circuitry combining circuit elements such as a semiconductor element.

From the above description, it is possible to grasp the imaging device described in the following additional item 1.

[Additional Item 1]

An imaging device comprising:

a touch panel display composed of a display unit and a transparent touch-type operation unit disposed on a screen of the display unit in an overlapped manner;

a display control processor that displays an enlarged image obtained by enlarging a partial region of a captured image in a case where the captured image is reproduced and displayed on the screen, moves an enlargement display region, which is a partial region of the captured image to be displayed as the enlarged image, into a region of the captured image in response to a gesture operation performed by a finger of a user touching the touch-type operation unit, and displays a guide frame composed of an outer frame indicating the region of the captured image and an inner frame indicating the enlargement display region on the screen in addition to the enlarged image;

a reception processor that receives a setting instruction for a correspondence relationship between an operation direction of the gesture operation and a movement direction of the enlargement display region;

a setting processor that sets the correspondence relationship in response to the setting instruction; and

a deciding processor that decides the movement direction in the region of the captured image based on the correspondence relationship in a case where the gesture operation is performed,

wherein the display control processor moves the enlargement display region in the movement direction decided by the deciding processor.

In each of the above embodiments, the lens interchangeable type digital camera 10 is exemplified as an example of the imaging device, but the present invention is not limited thereto. The present invention is also adaptable to a digital camera in which a lens portion is provided integrally with a camera body. The present invention is also adaptable to a video camera, a mobile phone with a camera, or the like.

Needless to say, the invention is not limited to each of the above embodiments, and various configurations may be employed without departing from the gist of the present invention.

### EXPLANATION OF REFERENCES

10: digital camera (imaging device)
11: lens barrel
12: imaging optical system
13: image sensor
14: power lever
15: release switch
16: hot shoe
17: viewfinder part
18: object window
19: eyepiece window
20: touch panel display
21: operation key group
22: direction instruction key
23: menu/decision key
24: reproduction display key
25: return key
26: lid
30: display unit
31: touch-type operation unit
32: screen
35: enlargement display region
36: enlargement ratio display bar
37: guide frame
40: bar body
41: mark
42: outer frame
43: inner frame
50: setting image
51, 111: radio button
52, 112: setting button
53, 113: cancel button
60: movable lens
61: stop mechanism
65: analog front end (AFE)
66: digital signal processor (DSP)
67: sensor control unit
68: optical system controller
69: CPU
70: frame memory
71: card control unit
72: storage unit
73: data bus
75: operation program
76: memory card
80: gesture operation recognition information
81: command conversion information
82: first correspondence relationship information
83: second correspondence relationship information
90, 91: first and second reception units (reception unit)
92: recognition unit
93: command output unit (deciding unit)
94: information management unit (setting unit)
95: display control unit
100A: portion of swipe operation or flick operation of command conversion information
100B: portion of direction instruction key operation of command conversion information
105: first warning image
106, 121: message
107, 122: Yes button
108, 123: No button
110: display setting image
120: second warning image
F: finger
K to N, P to V: arrow
OA: optical axis
ST100 to ST104, ST110 to ST117, ST200 to ST203, ST210 to ST217, ST300 to
ST307, ST400 to ST406: step

What is claimed is:

1. An imaging device comprising:
a touch display; and
a processor configured to:
display an enlarged image obtained by enlarging a partial region of a captured image in a case where the captured image is reproduced and displayed on the touch display, move an enlargement display region, which is a partial region of the captured image to be displayed as the enlarged image, into a region of the captured image in response to a gesture operation performed by a finger of a user touching the touch display, and display a guide frame composed of an outer frame indicating the region of the captured image and an inner frame indicating the enlargement display region on the touch display in addition to the enlarged image;
receive a setting instruction for a correspondence relationship between an operation direction of the gesture operation and a movement direction of the enlargement display region;
set the correspondence relationship in response to the setting instruction; and
decide the movement direction in the region of the captured image based on the correspondence relationship in a case where the gesture operation is performed,
wherein the processor moves the enlargement display region in the decided movement direction.

2. The imaging device according to claim 1, wherein the processor moves the inner frame with respect to the outer frame according to the movement of the enlargement display region in a state where a display position of the outer frame in the touch display is fixed, and
switches between display and non-display of the guide frame according to the correspondence relationship.

3. The imaging device according to claim 2, wherein the processor displays the guide frame in a case of the correspondence relationship in which the operation direction matches the movement direction, and
does not display the guide frame in a case of the correspondence relationship in which the operation direction is different from the movement direction.

4. The imaging device according to claim 1, wherein:
the processor receives an instruction to perform display or non-display of the guide frame,
moves the inner frame with respect to the outer frame according to the movement of the enlargement display region in a state where a display position of the outer frame in the touch display is fixed, and
switches between the display and the non-display of the guide frame according to the instruction to perform the display or non-display of the guide frame.

5. The imaging device according to claim 4, wherein the processor receives an instruction to perform the display of the guide frame as the setting instruction for the correspondence relationship in which the operation direction matches the movement direction, and
receives an instruction to perform the non-display of the guide frame as the setting instruction for the correspondence relationship in which the operation direction is different from the movement direction.

6. The imaging device according to claim 2, wherein the processor displays a first warning image for inquiring whether or not the non-display of the guide frame is allowed on the touch display in a case where the guide frame is not displayed.

7. The imaging device according to claim 1, wherein the processor switches the display of the guide frame, according to the correspondence relationship, between an inner frame movement type in which a display position of the outer frame in the touch display is fixed and the inner frame is moved with respect to the outer frame according to the movement of the enlargement display region and an outer frame movement type in which a display position of the inner frame in the touch display is fixed and the outer frame is moved with respect to the inner frame according to the movement of the enlargement display region.

8. The imaging device according to claim 7, wherein the processor sets the inner frame movement type in a case of the correspondence relationship in which the operation direction matches the movement direction, and
sets the outer frame movement type in a case of the correspondence relationship in which the operation direction is different from the movement direction.

9. The imaging device according to claim 1, wherein the processor displays a second warning image for inquiring whether or not a setting in which the operation direction matches the movement direction is allowed on the touch display in a case where the processor receives the setting instruction for the correspondence relationship in which the operation direction matches the movement direction.

10. The imaging device according to claim 1, further comprising:
a direction instruction key,
wherein the processor moves the enlargement display region in a direction that matches a direction as instructed by the direction instruction key, and moves the inner frame with respect to the outer frame according to the movement of the enlargement display region in a state where the display position of the outer frame in the touch display is fixed.

11. The imaging device according to claim 1, wherein the gesture operation includes at least one of a swipe operation in which a finger is brought to touch the touch display, is slowly moved in a certain direction, and then is released from the touch display, or a flick operation in which a finger is brought to touch the touch display and is quickly swept in a certain direction to be released from the touch display.

12. An operation method of an imaging device including a touch display, the method comprising:
a display control step of displaying an enlarged image obtained by enlarging a partial region of a captured image in a case where the captured image is reproduced and displayed on the touch display, moving an enlargement display region, which is a partial region of the captured image to be displayed as the enlarged image, into a region of the captured image in response to a gesture operation performed by a finger of a user touching the touch display, and displaying a guide frame composed of an outer frame indicating the region of the captured image and an inner frame indicating the enlargement display region on the touch display in addition to the enlarged image;
a reception step of receiving a setting instruction for a correspondence relationship between an operation direction of the gesture operation and a movement direction of the enlargement display region;
a setting step of setting the correspondence relationship in response to the setting instruction; and
a deciding step of deciding the movement direction in the region of the captured image based on the correspondence relationship in a case where the gesture operation is performed,
wherein in the display control step, the enlargement display region is moved in the movement direction decided in the deciding step.

13. A non-transitory computer readable medium for storing a computer-executable program for an imaging device including a touch display, the computer-executable program causing a computer to execute:
a display control function of displaying an enlarged image obtained by enlarging a partial region of a captured image in a case where the captured image is reproduced and displayed on the touch display, moving an enlargement display region, which is a partial region of the captured image to be displayed as the enlarged image, into a region of the captured image in response to a gesture operation performed by a finger of a user touching the touch display, and displaying a guide frame composed of an outer frame indicating the region of the captured image and an inner frame indicating the enlargement display region on the touch display in addition to the enlarged image;
a reception function of receiving a setting instruction for a correspondence relationship between an operation direction of the gesture operation and a movement direction of the enlargement display region;
a setting function of setting the correspondence relationship in response to the setting instruction; and
a deciding function of deciding the movement direction in the region of the captured image based on the correspondence relationship in a case where the gesture operation is performed,
wherein the display control function moves the enlargement display region in the movement direction decided by the deciding function.
